(19) United States
(12) Patent Application Publication
(10) Pub. No.: US 2025/0285241 A1
(43) Pub. Date: Sep. 11, 2025

(54) DEBLURRING IMAGES

(71) Applicant: QUALCOMM Incorporated, San Diego, CA (US)

(72) Inventors: Satyajit GIRI, San Diego, CA (US); Dharanya VANCHINATHAN, San Diego, CA (US); Narayana Karthik RAVIRALA, San Diego, CA (US); Shizhong LIU, San Diego, CA (US)

(21) Appl. No.: 18/600,285

(22) Filed: Mar. 8, 2024

(51) Int. Cl. G06T 5/73; G06T 5/50; G06T 5/60; G06T 7/00; G06T 7/13; G06T 7/246

(52) U.S. Cl. CPC G06T 5/73; G06T 5/50; G06T 5/60; G06T 7/0002; G06T 7/13; G06T 7/246; G06T 2207/20081; G06T 2207/20084; G06T 2207/20201; G06T 2207/20212; G06T 2207/30168; G06T 2207/30201

(57) ABSTRACT

Systems and techniques are described herein for deblurring images. For instance, a method for deblurring images is provided. The method may include identifying, using motion analysis, a portion of an image; identifying an edge associated with the portion; determining an amount of blur of the edge; based on the amount of blur of the edge exceeding a blur threshold, deblurring the portion of the image to generate a deblurred portion of the image; and combining the deblurred portion of the image with other image data to generate a deblurred image.

### TECHNICAL FIELD

The present disclosure generally relates to image modification. For example, aspects of the present disclosure include systems and techniques for deblurring images.

### BACKGROUND

A camera can receive light and capture image frames, such as still images or video frames, using an image sensor. Cameras can be configured with a variety of image-capture settings and/or image-processing settings to alter the appearance of images captured thereby. Image-capture settings may be determined and applied before and/or while an image is captured, such as ISO, exposure time (also referred to as exposure, exposure duration, or shutter speed), aperture size, (also referred to as f/stop), focus, and gain (including analog and/or digital gain), among others. Image-processing settings can be configured for post-processing of an image, such as alterations to contrast, brightness, saturation, sharpness, levels, curves, and colors, among others.

In photography, the term “exposure,” relating to an image captured by a camera, refers to the amount of light per unit area that reaches a photographic film, or in modern cameras, an electronic image sensor (e.g., including an array of photodiodes). The exposure is based on certain image-capture settings such as, for example, exposure time, and/or lens aperture, as well as the luminance of the scene being photographed. Because of the relationship between the amount of light that reaches an image sensor and the duration of time the image sensors is allowed to capture the light, in the present disclosure, the terms “exposure,” “exposure duration,” and “exposure time” may refer to a duration of time during which the electronic image sensor is exposed to light (e.g., while the electronic image sensor is capturing an image) and/or an amount of time during which light reaching an image sensor is recorded as a single image frame.

If a camera moves during an exposure (e.g., while light is being captured and recorded as an image), a resulting image may be blurry. For example, a pixel of an image sensor may receive light from two or more points in a scene because the camera (including the image sensor) moved relative to the scene while the image sensor was capturing light from the scene. The pixel may record values (e.g., red, green, and blue light-intensity values) based on the two or more points in the scene. The recorded values may be based on the two or more points in the scene and may thus not represent a single point in the scene and may thus be blurry. All of the pixels of the image sensor may be similarly affected and thus the image may be blurry. Similarly, if a subject (e.g., a person or an object) in the scene moves during an exposure, the subject may be blurry in the image.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for deblurring images. According to at least one example, a method is provided for deblurring images. The method includes: identifying, using motion analysis, a portion of an image; identifying an edge associated with the portion; determining an amount of blur of the edge; based on the amount of blur of the edge exceeding a blur threshold, deblurring the portion of the image to generate a deblurred portion of the image; and combining the deblurred portion of the image with other image data to generate a deblurred image.

In another example, an apparatus for deblurring images is provided that includes at least one memory and at least one processor (e.g., configured in circuitry) coupled to the at least one memory. The at least one processor configured to: identify, using motion analysis, a portion of an image; identify an edge associated with the portion; determine an amount of blur of the edge; based on the amount of blur of the edge exceeding a blur threshold, deblur the portion of the image to generate a deblurred portion of the image; and combine the deblurred portion of the image with other image data to generate a deblurred image.

In another example, a non-transitory computer-readable medium is provided that has stored thereon instructions that, when executed by one or more processors, cause the one or more processors to: identify, using motion analysis, a portion of an image; identify an edge associated with the portion; determine an amount of blur of the edge; based on the amount of blur of the edge exceeding a blur threshold, deblur the portion of the image to generate a deblurred portion of the image; and combine the deblurred portion of the image with other image data to generate a deblurred image.

In another example, an apparatus for deblurring images is provided. The apparatus includes: means for identifying, using motion analysis, a portion of an image; means for identifying an edge associated with the portion; means for determining an amount of blur of the edge; means for based on the amount of blur of the edge exceeding a blur threshold, deblurring the portion of the image to generate a deblurred portion of the image; and means for combining the deblurred portion of the image with other image data to generate a deblurred image.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an example architecture of an image processing system, according to various aspects of the present disclosure;

FIG. 2 is a diagram illustrating a camera-readout process;

FIG. 3 includes three example images including blurry pixels;

FIG. 4 includes two example images;

FIG. 5 is a diagram illustrating an example system 500 for debluring images, according to various aspects of the present disclosure;

FIG. 6A is a diagram illustrating an example of a frame of a sequence of frames;

FIG. 6B is a diagram illustrating an example of a frame that is adjacent to the frame of

FIG. 6A in the sequence of frames;

FIG. 6C is a diagram illustrating an example of a frame that is adjacent to frame FIG. 6B in the sequence of frames;

FIG. 7 includes an example optical-flow map and a corresponding example image, according to various aspects of the present disclosure;

FIG. 8 is a block diagram illustrating an example of the blur detector of FIG. 5 to provide additional detail regarding operations of the blur detector, according to various aspects of the present disclosure;

FIG. 9 includes an image of edges, an optical-flow map, and an image of selected edges, according to various aspects of the present disclosure;

FIG. 10 includes an image overlaid with edges and an image overlaid with selected edges, according to various aspects of the present disclosure;

FIG. 11 includes an image and graphs to illustrate principles related to edge-width determination, according to various aspects of the present disclosure;

FIG. 12 is a block diagram illustrating an example of the deblurrer of FIG. 5 to provide additional detail regarding operations of the deblurrer, according to various aspects of the present disclosure.

FIG. 13 is a block diagram illustrating an example of the combiner of FIG. 5 to provide additional detail regarding operations of the combiner, according to various aspects of the present disclosure.

FIG. 14 includes three example images to illustrate performance of the system of FIG. 5, according to various aspects of the present disclosure;

FIG. 15 is a block diagram illustrating an example of the image evaluator of FIG. 5 to provide additional detail regarding operations of the image evaluator, according to various aspects of the present disclosure.

FIG. 16 includes two example images to illustrate various principles of the present disclosure;

FIG. 17 is a flow diagram illustrating another example process for deblurring images, in accordance with aspects of the present disclosure;

FIG. 18 is a block diagram illustrating an example of a deep learning neural network that can be used to perform various tasks, according to some aspects of the disclosed technology;

FIG. 19 is a block diagram illustrating an example of a convolutional neural network (CNN), according to various aspects of the present disclosure; and

FIG. 20 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Electronic devices (e.g., mobile phones, wearable devices (e.g., smart watches, smart glasses, etc.), tablet computers, extended reality (XR) devices (e.g., virtual reality (VR) devices, augmented reality (AR) devices, mixed reality (MR) devices, and the like), connected devices, laptop computers, etc.) are increasingly equipped with cameras to capture image frames, such as still images and/or video frames, for consumption. For example, an electronic device can include a camera to allow the electronic device to capture a video or image of a scene, a person, an object, etc. Additionally, cameras themselves are used in a number of configurations (e.g., handheld digital cameras, digital single-lens-reflex (DSLR) cameras, worn camera (including body-mounted cameras and head-borne cameras), stationary cameras (e.g., for security and/or monitoring), vehicle-mounted cameras, etc.).

A camera can receive light and capture image frames (e.g., still images or video frames) using an image sensor (which may include an array of photosensors). In some examples, a camera may include one or more processors, such as image signal processors (ISPs), that can process one or more image frames captured by an image sensor. For example, a raw image frame captured by an image sensor can be processed by an image signal processor (ISP) of a camera to generate a final image. In some cases, a camera, or an electronic device implementing a camera, can further process a captured image or video for certain effects (e.g., compression, image enhancement, image restoration, scaling, framerate conversion, etc.) and/or certain applications such as computer vision, extended reality (e.g., augmented reality, virtual reality, and the like), object detection, image recognition (e.g., face recognition, object recognition, scene recognition, etc.), feature extraction, authentication, and automation, among others.

Cameras can be configured with a variety of image-capture settings and/or image-processing settings to alter the appearance of an image. Image-capture settings can be determined and applied before or while an image is captured, such as ISO, exposure time (also referred to as exposure, exposure duration, and/or shutter speed), aperture size (also referred to as f/stop), focus, and gain, among others. Image-processing settings can be configured for post-processing of an image, such as alterations to a contrast, brightness, saturation, sharpness, levels, curves, and colors, among others.

As mentioned above, in photography, the term “exposure,” relating to an image captured by a camera, refers to the amount of light per unit area that reaches a photographic film, or in modern cameras, an electronic image sensor (e.g., including an array of photodiodes). The exposure is based on certain image-capture settings such as, for example, exposure time, and/or lens aperture, as well as the luminance of the scene being photographed. Because of the relationship between the amount of light that reaches an image sensor and the duration of time the image sensors is allowed to capture the light, in the present disclosure, the terms “exposure,” “exposure duration,” and “exposure time” may refer to a duration of time during which the electronic image sensor is exposed to light (e.g., while the electronic image sensor is capturing an image) and/or an amount of time during which light reaching an image sensor is recorded as a single image frame.

Based on the exposure duration, it takes a certain amount of time to capture an image. During that time, the camera or a subject of the image may move. For instance, if a subject (e.g., a person or an object) in a scene being captured by a camera moves while the camera is capturing an image of the scene, the subject may be blurry in the image. Further, if a camera moves while the camera is capturing an image (e.g., during an exposure), the image may be blurry.

Various techniques can be used to address blurry images. For example, one way to decrease blurry pixels based on movement (e.g., camera movement and/or subject movement) is to decrease the exposure duration when capturing images. However, shortening the exposure time may have other effects on images. For example, shortening an exposure time may not allow an image sensor to capture enough light, leaving images too dark. Additionally or alternatively, shortening an exposure time may introduce artifacts.

Another technique for decreasing blurry pixels is to determine a point spread function (PSF) (a transfer function) for an image and apply the inverse of the PSF to the image. Applying an inverse PSF may reduce blur in images which are uniformly blurry, for example, images captured by a camera that moved while the images were being captured. However, applying an inverse PSF to portions of an image that are not blurry may affect the non-blurry portions of the image.

Systems, apparatuses, methods (also referred to as processes), and computer-readable media (collectively referred to herein as “systems and techniques”) are described herein for deblurring images. For example, the systems and techniques described herein may obtain multiple images (e.g., captured in quick succession, such as five or six images captured within milliseconds of one another) and determine an anchor image from among the multiple images. The systems and techniques may also determine an optical-flow map based on the multiple images. The systems and techniques may evaluate a degree of blur of the anchor image, more specifically, the systems and techniques may determine a degree of blur of pixels of the anchor image that represent a moving subject based on the optical-flow map. If the pixels are not sufficiently blurry, the systems and techniques may output the anchor image. However, if the pixels are sufficiently blurry, the systems and techniques may determine to deblur a portion of the anchor image.

The systems and techniques may crop the anchor image based on the optical-flow map to select a portion of the anchor image that includes the blurry pixels (the blurry pixels may represent the moving subject). The systems and techniques may deblur the portion of the anchor image and reinsert the deblurred image portion into the anchor image. The systems and techniques may compare the original anchor image to the anchor image with the reinserted deblurred portion to determine whether the deblurring improved the anchor image. If the deblurring improved the anchor image, the systems and techniques may output the anchor image with the deblurred portion. If the deblurring did not improve the image, the systems and techniques may output the anchor image.

In some aspects, the systems and techniques may evaluate and/or modify images soon after the images are captured (e.g., in real-time or “live”). For example, the systems and techniques may evaluate and/or modify images as part of image-processing techniques of the camera (e.g., not after the images have been stored by cloud service).

The systems and techniques may implement several improvements to allow the systems and techniques to perform soon after the images are captured. For example, the systems and techniques may evaluate the blur of images to determine which images to deblur. An alternative approach may deblur every image. However, deblurring every image may be computationally expensive, for example, in terms of computational time and/or power. Thus, deblurring every image may not be desirable. Accordingly, the systems and techniques may evaluate blur of images (e.g., each images captured by the camera) to determine which images to deblur. By determining which images to deblur, instead of blurring all images, the systems and techniques may conserve computational resources compared to alternative approaches.

Additionally or alternatively, the systems and techniques may identify a blurred portion of the image and deblur the portion of the image rather than deblurring the entire image. By deblurring a portion of the image, rather than the entire image, the systems and techniques may conserve computational resources compared to alternative approaches that deblur entire images.

Additionally or alternatively, the systems and techniques may evaluate images with deblurred portions to determine whether the deblurring improved the image. An alternative approach may deblur images by default. In some cases, deblurring may degrade image quality, for example, deblurring may introduce artifacts to an image. By evaluating the images with the deblurred portions, the systems and techniques may output images that are improvements and not output images that are worse than the original images.

Various aspects of the application will be described with respect to the figures below.

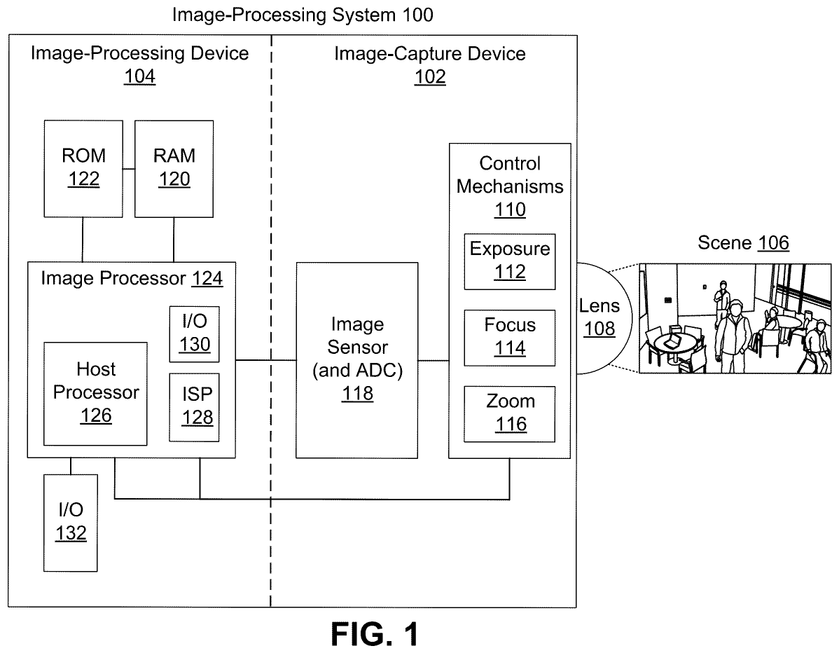

FIG. 1 is a block diagram illustrating an example architecture of an image-processing system 100, according to various aspects of the present disclosure. The image-processing system 100 includes various components that are used to capture and process images, such as an image of a scene 106. The image-processing system 100 can capture image frames (e.g., still images or video frames). In some cases, the lens 108 and image sensor 118 (which may include an analog-to-digital converter (ADC)) can be associated with an optical axis. In one illustrative example, the photosensitive area of the image sensor 118 (e.g., the photodiodes) and the lens 108 can both be centered on the optical axis.

In some examples, the lens 108 of the image-processing system 100 faces a scene 106 and receives light from the scene 106. The lens 108 bends incoming light from the scene toward the image sensor 118. The light received by the lens 108 then passes through an aperture of the image-processing system 100. In some cases, the aperture (e.g., the aperture size) is controlled by one or more control mechanisms 110. In other cases, the aperture can have a fixed size.

The one or more control mechanisms 110 can control exposure, focus, and/or zoom based on information from the image sensor 118 and/or information from the image processor 124. In some cases, the one or more control mechanisms 110 can include multiple mechanisms and components. For example, the control mechanisms 110 can include one or more exposure-control mechanisms 112, one or more focus-control mechanisms 114, and/or one or more zoom-control mechanisms 116. The one or more control mechanisms 110 may also include additional control mechanisms besides those illustrated in FIG. 1. For example, in some cases, the one or more control mechanisms 110 can include control mechanisms for controlling analog gain, flash, HDR, depth of field, and/or other image capture properties.

The focus-control mechanism 114 of the control mechanisms 110 can obtain a focus setting. In some examples, focus-control mechanism 114 stores the focus setting in a memory register. Based on the focus setting, the focus-control mechanism 114 can adjust the position of the lens 108 relative to the position of the image sensor 118. For example, based on the focus setting, the focus-control mechanism 114 can move the lens 108 closer to the image sensor 118 or farther from the image sensor 118 by actuating a motor or servo (or other lens mechanism), thereby adjusting the focus. In some cases, additional lenses may be included in the image-processing system 100. For example, the image-processing system 100 can include one or more microlenses over each photodiode of the image sensor 118. The microlenses can each bend the light received from the lens 108 toward the corresponding photodiode before the light reaches the photodiode.

In some examples, the focus setting may be determined via contrast detection autofocus (CDAF), phase detection autofocus (PDAF), hybrid autofocus (HAF), or some combination thereof. The focus setting may be determined using the control mechanism 110, the image sensor 118, and/or the image processor 124. The focus setting may be referred to as an image capture setting and/or an image processing setting. In some cases, the lens 108 can be fixed relative to the image sensor and the focus-control mechanism 114.

The exposure-control mechanism 112 of the control mechanisms 110 can obtain an exposure setting. In some cases, the exposure-control mechanism 112 stores the exposure setting in a memory register. Based on the exposure setting, the exposure-control mechanism 112 can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 118 (e.g., ISO speed or film speed), analog gain applied by the image sensor 118, or any combination thereof. The exposure setting may be referred to as an image capture setting and/or an image processing setting.

The zoom-control mechanism 116 of the control mechanisms 110 can obtain a zoom setting. In some examples, the zoom-control mechanism 116 stores the zoom setting in a memory register. Based on the zoom setting, the zoom-control mechanism 116 can control a focal length of an assembly of lens elements (lens assembly) that includes the lens 108 and one or more additional lenses. For example, the zoom-control mechanism 116 can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 108 in some cases) that receives the light from the scene 106 first, with the light then passing through a focal zoom system between the focusing lens (e.g., lens 108) and the image sensor 118 before the light reaches the image sensor 118. The focal zoom system may, in some cases, include two positive (e.g., converging, convex) lenses of equal or similar focal length (e.g., within a threshold difference of one another) with a negative (e.g., diverging, concave) lens between them. In some cases, the zoom-control mechanism 116 moves one or more of the lenses in the focal zoom system, such as the negative lens and one or both of the positive lenses. In some cases, zoom-control mechanism 116 can control the zoom by capturing an image from an image sensor of a plurality of image sensors (e.g., including image sensor 118) with a zoom corresponding to the zoom setting. For example, the image-processing system 100 can include a wide-angle image sensor with a relatively low zoom and a telephoto image sensor with a greater zoom. In some cases, based on the selected zoom setting, the zoom-control mechanism 116 can capture images from a corresponding sensor.

The image sensor 118 includes one or more arrays of photodiodes or other photosensitive elements. Each photodiode measures an amount of light that eventually corresponds to a particular pixel in the image produced by the image sensor 118. In some cases, different photodiodes may be covered by different filters. In some cases, different photodiodes can be covered in color filters, and may thus measure light matching the color of the filter covering the photodiode. Various color filter arrays can be used such as, for example and without limitation, a Bayer color filter array, a quad color filter array (QCFA), and/or any other color filter array.

In some cases, the image sensor 118 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an infrared (IR) cut filter, an ultraviolet (UV) cut filter, a band-pass filter, low-pass filter, high-pass filter, or the like). The image sensor 118 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 110 may be included instead or additionally in the image sensor 118. The image sensor 118 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

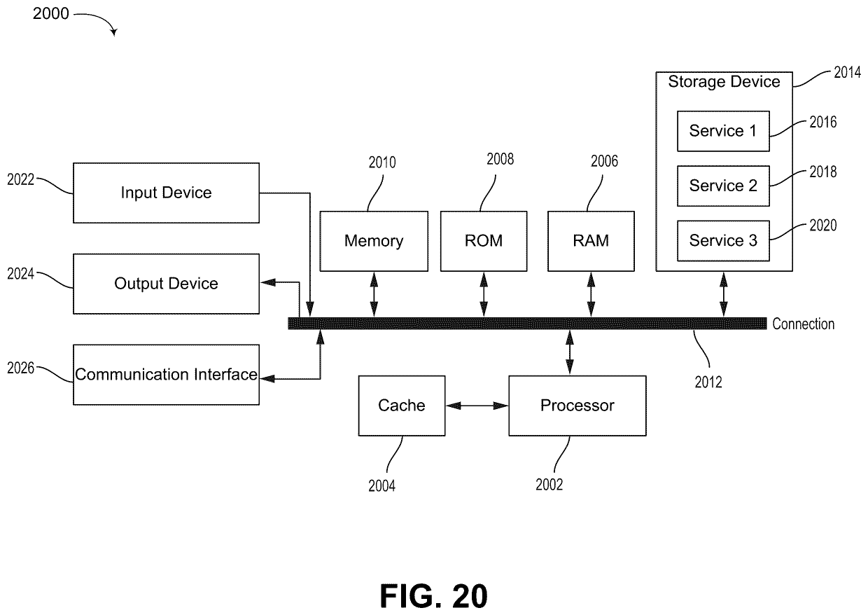

The image processor 124 may include one or more processors, such as one or more image signal processors (ISPs) (including ISP 128), one or more host processors (including host processor 126), and/or one or more of any other type of processor discussed with respect to the computing-device architecture 2000 of FIG. 20. The host processor 126 can be a digital signal processor (DSP) and/or other type of processor. In some implementations, the image processor 124 is a single integrated circuit or chip (e.g., referred to as a system-on-chip or SoC) that includes the host processor 126 and the ISP 128. In some cases, the chip can also include one or more input/output ports (e.g., input/output (I/O) ports 130), central processing units (CPUs), graphics processing units (GPUs), broadband modems (e.g., third generation (3G), fourth generation (4G) or long-term evolution (LTE), 5G, etc.), memory, connectivity components (e.g., Bluetooth™, Global Positioning System (GPS), etc.), any combination thereof, and/or other components. The I/O ports 130 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General-Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 126 can communicate with the image sensor 118 using an I2C port, and the ISP 128 can communicate with the image sensor 118 using an MIPI port.

The image processor 124 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 124 may store image frames and/or processed images in random-access memory (RAM) 120, read-only memory (ROM) 122, a cache, a memory unit, another storage device, or some combination thereof.

Various input/output (I/O) devices 132 may be connected to the image processor 124. The I/O devices 132 can include a display screen, a keyboard, a keypad, a touchscreen, a trackpad, a touch-sensitive surface, a printer, any other output devices, any other input devices, or any combination thereof. In some cases, a caption may be input into the image-processing device 104 through a physical keyboard or keypad of the I/O devices 132, or through a virtual keyboard or keypad of a touchscreen of the I/O devices 132. The I/O devices 132 may include one or more ports, jacks, or other connectors that enable a wired connection between the image-processing system 100 and one or more peripheral devices, over which the image-processing system 100 may receive data from the one or more peripheral device and/or transmit data to the one or more peripheral devices. The I/O devices 132 may include one or more wireless transceivers that enable a wireless connection between the image-processing system 100 and one or more peripheral devices, over which the image-processing system 100 may receive data from the one or more peripheral device and/or transmit data to the one or more peripheral devices. The peripheral devices may include any of the previously-discussed types of the I/O devices 132 and may themselves be considered I/O devices 132 once they are coupled to the ports, jacks, wireless transceivers, or other wired and/or wireless connectors.

In some cases, the image-processing system 100 may be a single device. In some cases, the image-processing system 100 may be two or more separate devices, including an image-capture device 102 (e.g., a camera) and an image-processing device 104 (e.g., a computing device coupled to the camera). In some implementations, the image-capture device 102 and the image-capture device 102 may be coupled together, for example via one or more wires, cables, or other electrical connectors, and/or wirelessly via one or more wireless transceivers. In some implementations, the image-capture device 102 and the image-processing device 104 may be disconnected from one another.

As shown in FIG. 1, a vertical dashed line divides the image-processing system 100 of FIG. 1 into two portions that represent the image-capture device 102 and the image-processing device 104, respectively. The image-capture device 102 includes the lens 108, control mechanisms 110, and the image sensor 118. The image-processing device 104 includes the image processor 124 (including the ISP 128 and the host processor 126), the RAM 120, the ROM 122, and the I/O device 132. In some cases, certain components illustrated in the image-capture device 102, such as the ISP 128 and/or the host processor 126, may be included in the image-capture device 102. In some examples, the image-processing system 100 can include one or more wireless transceivers for wireless communications, such as cellular network communications, 802.11 wi-fi communications, wireless local area network (WLAN) communications, or some combination thereof.

The image-processing system 100 can be part of, or implemented by, a single computing device or multiple computing devices. In some examples, the image-processing system 100 can be part of an electronic device (or devices) such as a camera system (e.g., a digital camera, an IP camera, a video camera, a security camera, etc.), a telephone system (e.g., a smartphone, a cellular telephone, a conferencing system, etc.), a laptop or notebook computer, a tablet computer, a set-top box, a smart television, a display device, a game console, an XR device (e.g., an head-mounted device (HMD), smart glasses, etc.), an IoT (Internet-of-Things) device, a smart wearable device, a video streaming device, an Internet Protocol (IP) camera, or any other suitable electronic device(s).

While the image-processing system 100 is shown to include certain components, one of ordinary skill will appreciate that the image-processing system 100 can include more components than those shown in FIG. 1. The components of the image-processing system 100 can include software, hardware, or one or more combinations of software and hardware. For example, in some implementations, the components of the image-processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image-processing system 100.

In some examples, the computing-device architecture 2000 shown in FIG. 20 and further described below can include the image-processing system 100, the image-capture device 102, the image-processing device 104, or a combination thereof.

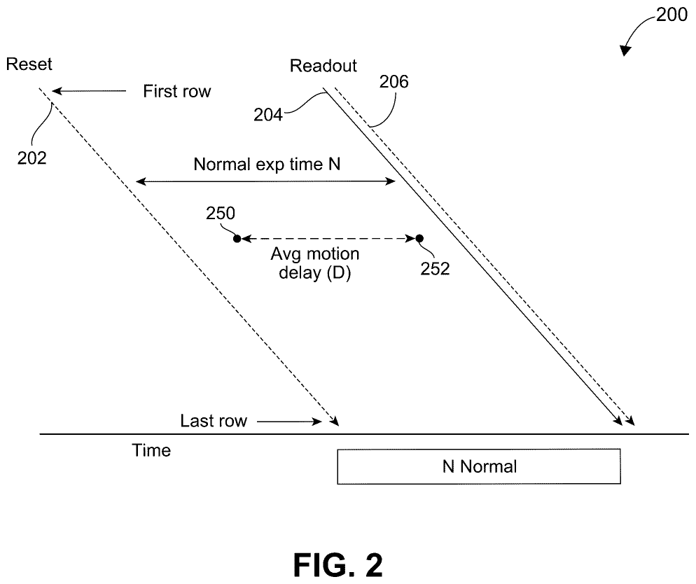

FIG. 2 is a diagram 200 illustrating a camera-readout process. In the diagram 200, the x axis represents time (e.g., a camera stream readout over time, such as a Mobile Industry Processor Interface (MIPI) stream), and the y axis represents rows of an image sensor (e.g., image sensor 118 of FIG. 1). Lines 202 and 206 represent a reset of the image sensor, corresponding to the start of an image capture (e.g., when the image sensor is exposed for capturing an image). Line 204 represents a readout from the image sensor, corresponding to the end of the image capture. For example, the image sensor is exposed to light for a period of time (shown as N Normal, between lines 202 and 204), and then there is a readout of the image sensor data for processing (e.g., by an ISP, such as image processing device 104 of FIG. 1). The image capture starts from the first row (e.g., row of photodiodes) of the image sensor and continues to the last row of the sensor, as shown along the y axis.

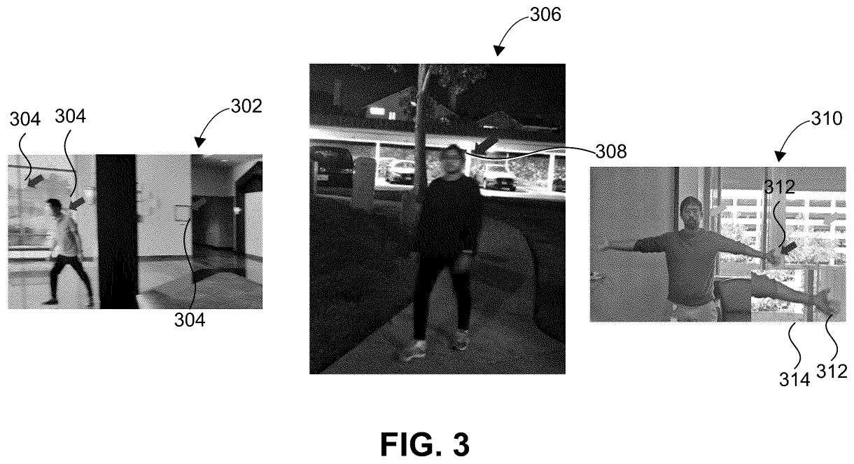

As illustrated in diagram 200 of FIG. 2, it takes time to capture an image. During that time, the camera or a subject of the image may move. For instance, if a subject (e.g., a person or an object) in a scene being captured by a camera moves while the camera is capturing an image of the scene, the subject may be blurry in the image. Referring to FIG. 2, when an object is moving, the same object may be detected by different pixels in the sensor (represented by point 250 and point 252). If the object has moved by more than a certain amount (e.g., by more than two or three pixels) within one readout, then significant blurring of the image can be observed. FIG. 3 illustrates an image 306 that includes pixels 308 representing a subject that moved while image 306 was being captured. Some pixels of image 306 are sharp. However, pixels 308 that represent the subject are blurry because the subject moved while image 306 was being captured. Similarly, most of the pixels of image 310 of FIG. 3 are sharp. However, a hand of the subject of image 310 moved while image 310 was being captured. Thus, as can be seen in inset 314, pixels 312 of image 310 that represent the hand are blurry.

Further, if a camera moves while the camera is capturing an image (e.g., during an exposure), the image may be blurry. For example, image 302 of FIG. 3 is generally blurry based on the camera which captured image 302 having moved while image 302 was being captured. Camera movements may be the result of holding a camera in a hand while capturing images.

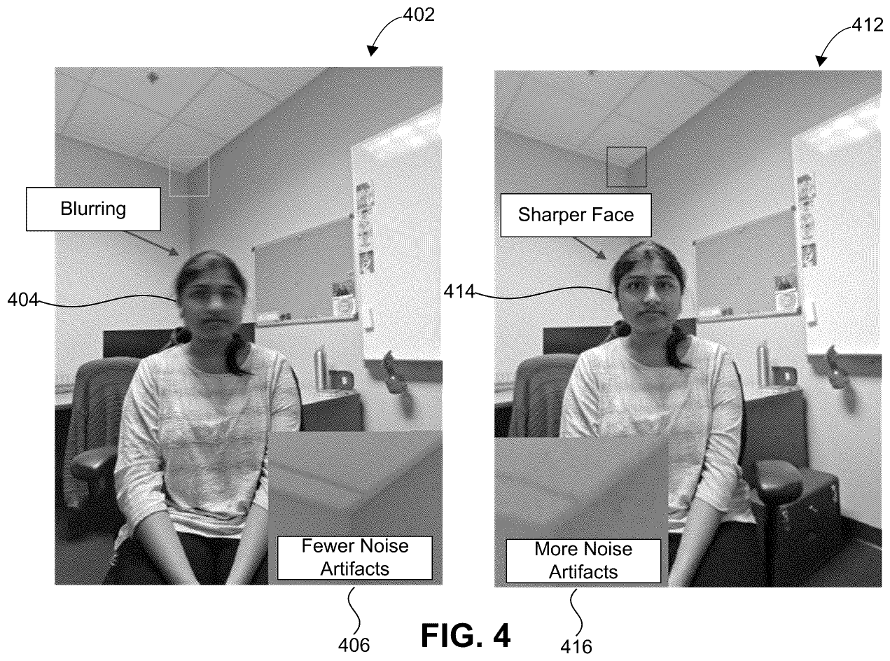

One way to decrease blurry pixels based on movement (e.g., camera movement and/or subject movement) is to decrease the exposure duration when capturing images. For example, image 402 of FIG. 4 is an example of an image captured according to a first exposure duration. A head of the subject of image 402 moved while image 402 was being captured. Thus, pixels 404, representing a face of the subject are blurry. In contrast, image 412 of FIG. 4 is an example of an image captured according to a second exposure duration. The second exposure duration is shorter than the first exposure duration. Even though the head of the subject moved while image 412 was being captured, pixels 414, representing the face of the subject, are sharper than pixels 404. Pixels 414 are sharper than pixels 404 because the time during which pixels 414 were captured was shorter than the time during which pixels 404 were captured thus the subject moved less during the time in which pixels 414 were captured than during the time in which pixels 404 were captured.

However, shortening the exposure time may have other effects on images. For example, shortening an exposure time may not allow an image sensor to capture enough light, leaving images too dark. Additionally or alternatively, shortening an exposure time may introduce artifacts. For example, inset 416 of image 412 includes more artifacts than inset 406 of image 402. For example, inset 416 is less clear than inset 406.

Another way to decrease blurry pixels is to determine a point spread function (PSF) (a transfer function) for an image and apply the inverse of the PSF to the image. Applying an inverse PSF may reduce blur in images which are uniformly blurry, for example, images captured by a camera that moved while the images were being captured. For example, applying an inverse PSF to image 302 of FIG. 3 may reduce the blur of image 302. However, applying an inverse PSF to portions of an image that are not blurry may affect the non-blurry portions of the image. For example, applying an inverse PSF to image 306 of FIG. 3 may cause non-blurry portions of image 306 to become blurry and/or to include artifacts.

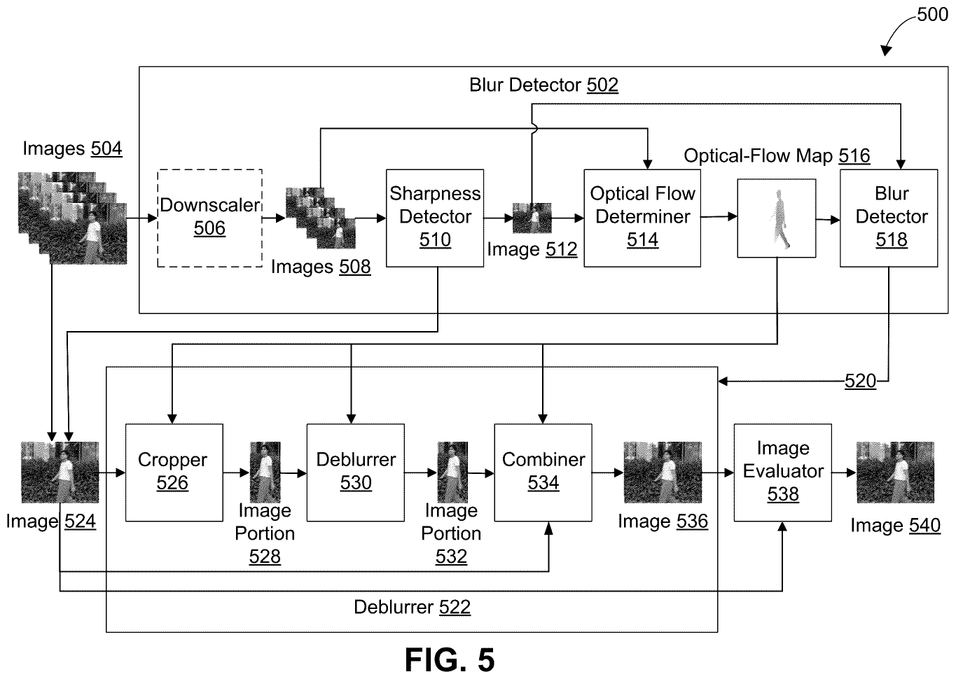

As noted previously, systems and techniques are described herein for deblurring images. FIG. 5 is a diagram illustrating an example system 500 for debluring images, according to various aspects of the present disclosure. In general, system 500 includes a blur detector 502 that may detect blur and determine whether to deblur an image (or a portion of the image), a deblurrer 522 that may deblur the image (or deblur the portion of the image and insert the deblurred portion into the image), and an image evaluator 538 that may determine whether the deblurred image (or the image with the deblurred portion) is better than the original image.

System 500 may obtain images 504. Images 504 may include multiple images captured in succession (e.g., according to a burst-capture mode of operation). Images 504 may be captured within milliseconds of one another (e.g., within 33 milliseconds of one another according to a camera capturing images 504 at a frame capture rate of 30 frames per second (fps)).

In some aspects, blur detector 502 may include a downscaler 506. Downscaler 506 may downscale images 504 (e.g., by reducing dimensions of each of images 504 by a scaling factor, such as two) resulting in images 508. By downscaling images 504 into images 508, blur detector 502 may conserve computational resources (e.g., computational time and/or power) when processing images 508 as compared with processing images 504. In some aspects, downscaler 506 may be omitted and blur detector 502 may process images 504. In such aspects, sharpness detector 510 and optical flow determiner 514 may process images 504 rather than images 508.

Sharpness detector 510 of blur detector 502 may determine a sharp image (image 512) (which may be referred to as an anchor image) from among images 508. Image 512 may be a sharpest image (or a sufficiently sharp image) selected from among images 508.

Optical flow determiner 514 of blur detector 502 may determine optical-flow map 516 based on image 512 and images 508. Optical flow determiner 514 may implement an optical-flow technique (e.g., Real-Time Intermediate Flow Estimation (RIFE)) to determine optical-flow map 516. Optical flow determiner 514 may identify pixels that change between successive images of images 508. Thus, optical-flow map 516 may indicate which pixels of image 512 are different from corresponding pixels of a prior and/or a subsequent image of images 508.

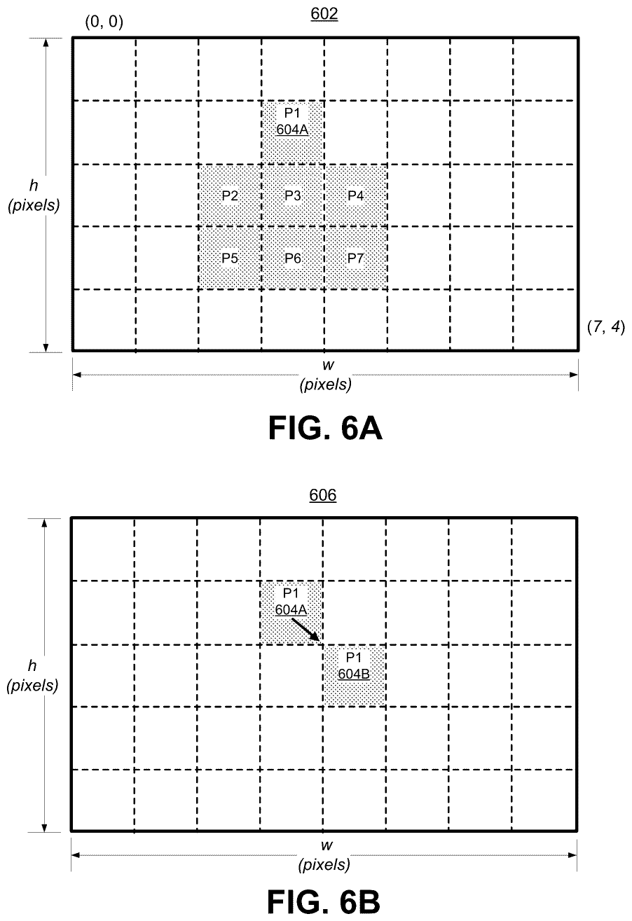

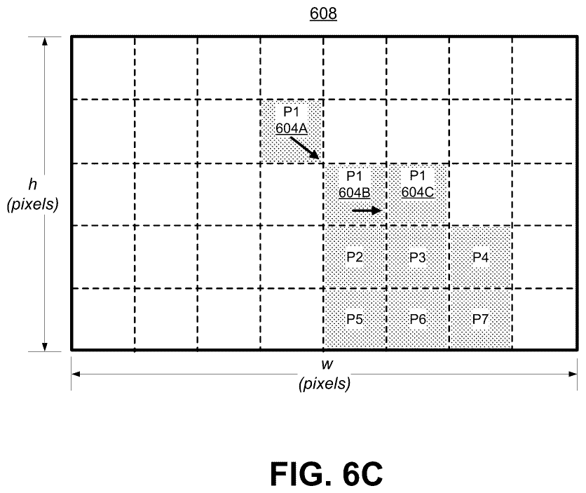

FIG. 6A, FIG. 6B, and FIG. 6C illustrate example frames to illustrate concepts related to determining an optical-flow vector and/or optical-flow map. Optical flow determiner 514 may determine optical-flow map 516 according to the concepts illustrated by the example of FIG. 6A, FIG. 6B, and FIG. 6C.

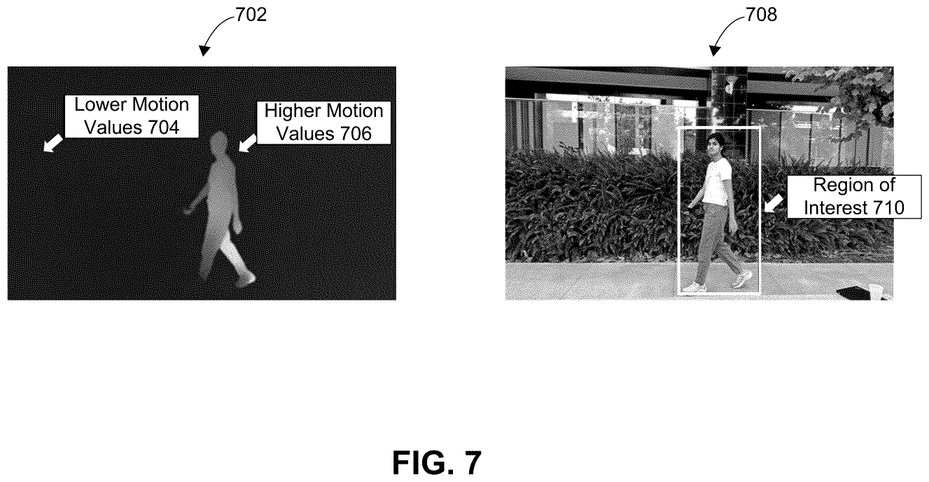

FIG. 7 includes an example optical-flow map 702 and a corresponding example image 708. Optical-flow map 702 includes pixel values indicative of relatively low motion (e.g., lower motion values 704, which may include pixels indicating no motion) and pixel values indicative of relatively high motion (e.g., higher motion values 706). The higher motion values 706 may be characterized by having higher motion values than lower motion values 704. Image 708 is overlaid with a box indicating a region of interest 710 (ROI 710). ROI 710 may be identified as a region of image 708 including pixels that represent a moving subject (e.g., based on optical-flow map 702).

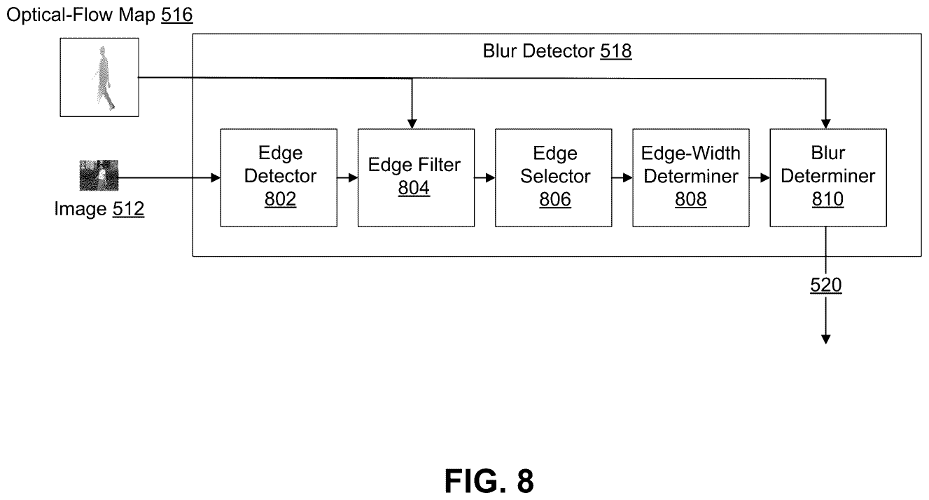

Returning to FIG. 5, blur detector 518 may determine whether to deblur image 512 (or at least a portion of image 512). Generally, blur detector 518 may examine blurriness of pixels of image 512 to determine whether to deblur image 512. Blur detector 518 may examine the blurriness of pixels that represent moving subjects (e.g., as identified by optical-flow map 516) to determine whether to deblur image 512. Blur detector 518 may output determination 520 indicative of whether to deblur image 512. FIG. 8 is a block diagram illustrating an example of blur detector 518 to provide additional detail regarding operations of blur detector 518.

Returning to FIG. 5, if blur detector 518 determines not to deblur image 512 (e.g., based on image 512 not being sufficiently blurry), system 500 may output image 524. Image 524 may be a full-scale instance of image 512. For instance, image 524 may be the full-scale instance of the sharpest of images 508 as selected by sharpness detector 510. If blur detector 518 determines to deblur image 512 (e.g., based on image 512 being sufficiently blurry), blur detector 518 may provide determination 520 and image 524 to deblurrer 522 and deblurrer 522 may deblur image 524.

Cropper 526 of deblurrer 522 may crop image 524 to obtain image portion 528. For example, cropper 526 may select a portion of image 524 corresponding to a moving object. For instance, cropper 526 may select a portion of image 524 based on optical-flow map 516. For example, cropper 526 may select image portion 528 based on a region of interest (ROI) (such as ROI 710 of image 708 of FIG. 7) that is identified based on motion values (e.g., of optical-flow map 702).

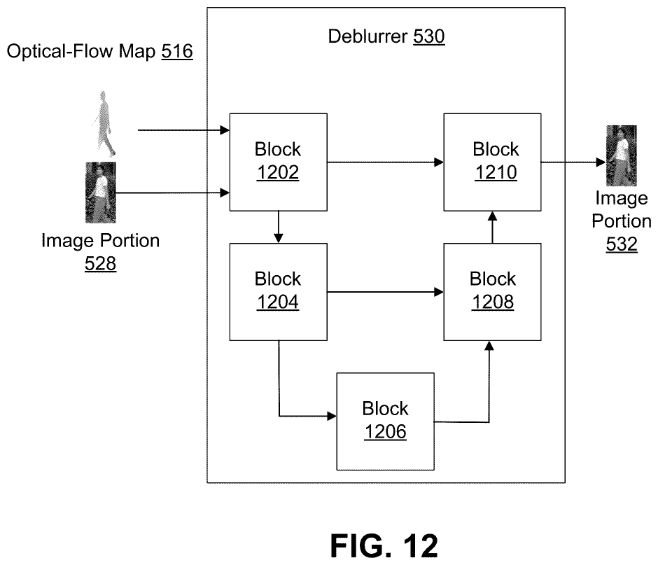

Deblurrer 530 of deblurrer 522 may deblur image portion 528. Deblurrer 530 may be, or may include, a machine-learning model trained to deblur images. For example, deblurrer 530 may include a machine-learning model including a U-net architecture of encoders and decoders trained to generate a deblurred image based on a blurry image and/or an optical-flow map. FIG. 12 is a block diagram illustrating an example of deblurrer 530 to provide additional detail regarding operations of deblurrer 530.

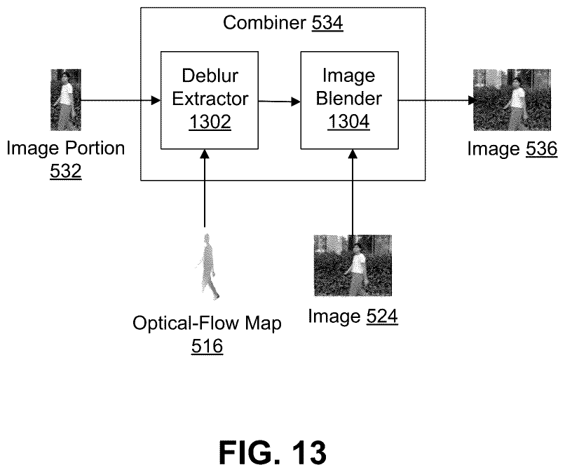

Returning to FIG. 5, combiner 534 may combine image portion 532 with image 524 to generate image 536. For example, combiner 534 may insert image portion 532 into image 524 (e.g., replacing pixels of image 524 with pixels of image 524). In some aspects, combiner 534 may blend pixels of image portion 532 with pixels of image 524. For example, combiner 534 may blend pixels at edges of image portion 532 with corresponding pixels of image 524. FIG. 13 is a block diagram illustrating an example of combiner 534 to provide additional detail regarding operations of combiner 534.

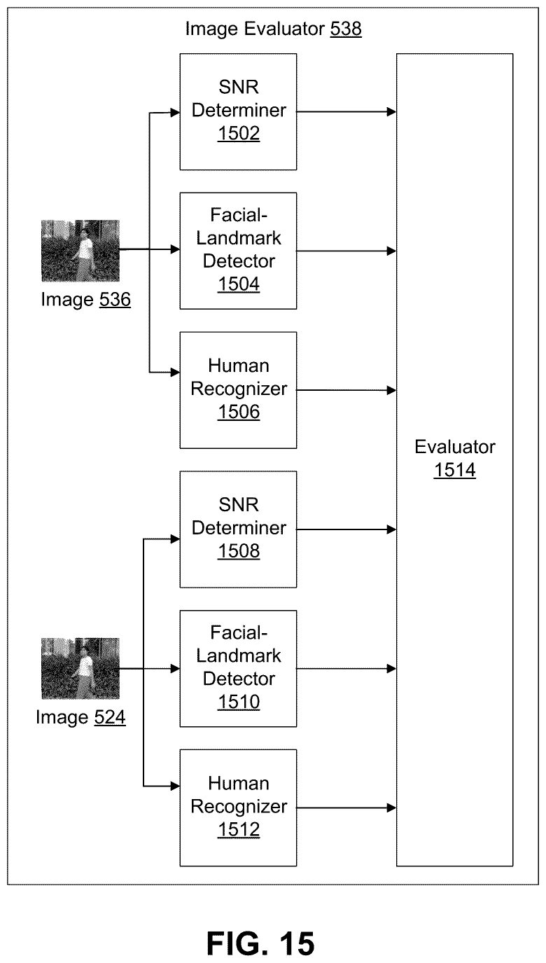

Returning to FIG. 5, image evaluator 538 may compare image 536 with image 524 to determine whether deblurrer 522 improved image 524. Image evaluator 538 may compare image 524 to image 536 at least in terms of a signal to noise ratio, an ability to recognize facial landmarks, and/or an ability to recognize humans. FIG. 15 is a block diagram illustrating an example of image evaluator 538 to provide additional detail regarding operations of image evaluator 538.

FIG. 6A is a diagram illustrating an example of a frame 602 of a sequence of frames, shown with foreground pixels P1, P2, P3, P4, P5, P6, and P7 (corresponding to an object of interest) at illustrative pixel locations. The other pixels in the frame 602 can be considered background pixels. Frame 602 is shown with dimensions of w pixels wide by h pixels high (denoted as w×h). One of ordinary skill will understand that frame 602 can include many more pixel locations than those illustrated in FIG. 6A. For example, frame 602 can include a 4K (or ultra-high definition (UHD)) frame at a resolution of 3,840×2,160 pixels, an HD frame at a resolution of 1,920×1,080 pixels, or any other suitable frame having another resolution. A pixel Pl is shown at a pixel location 604A. Pixel location 604A can include a (w, h) pixel location of (3, 1) relative to the top-left-most pixel location of (0, 0). The pixel P1 is used for illustrative purposes and can correspond to any suitable point on the object of interest, such as the point of a nose of a person.

FIG. 6B is a diagram illustrating an example of a frame 606 that is adjacent to the frame 602 in the sequence of frames. For instance, frame 606 can occur immediately after frame 602 in the sequence of frames. Frame 606 has the same corresponding pixel locations as that of frame 602 (with dimension w×h). As shown, the pixel P1 has moved from pixel location 604A in frame 602 to an updated pixel location 604B in frame 606. The updated pixel location 604B can include a (w, h) pixel location of (4, 2) relative to the top-left-most pixel location of (0, 0). An optical-flow vector can be computed for the pixel P1, indicating the velocity or optical flow of the pixel Pl from frame 602 to frame 606. In one illustrative example, the optical-flow vector for the pixel Pl between the frame 602 and frame 606 is (1, 1), indicating the pixel P1 has moved one pixel location to the right and one pixel location down.

FIG. 6C is a diagram illustrating an example of a frame 608 that is adjacent to frame 606 in the sequence of frames. For instance, frame 608 can occur immediately after frame 606 in the sequence of frames. Frame 608 has the same corresponding pixel locations as that of frame 602 and frame 606 (with dimensions w×h). As shown, the pixel P1 has moved from pixel location 604B in frame 606 to an updated pixel location 604C in frame 608. The updated pixel location 604C can include a (w, h) pixel location of (5, 2) relative to the top-left-most pixel location of (0, 0). An optical flow vector can be computed for the pixel P1 from frame 606 to frame 608. In one illustrative example, the optical flow vector for the pixel P1 between the frame 606 and frame 608 is (1, 0), indicating the pixel P1 has moved one pixel location to the right. The cumulative optical flow for the pixel P1 from frame 602 to frame 608 can be determined as O_{1,3}=cof(O_{1,2}, O_{2,3}). Using the examples from above, the cumulative optical flow vector O_{1,3} has an (x, y) value equal to (2, 1) based on the sum of the x- and y-directions of the optical flow vectors−cof((1, 1), (1, 0))=(1+1, 1+0). A similar cumulative optical flow can be determined for all other pixels in frame 602, frame 606, and frame 608.

FIG. 8 is a block diagram illustrating an example of blur detector 518 of FIG. 5 to provide additional detail regarding operations of blur detector 518, according to various aspects of the present disclosure. In general, blur detector 518 may determine whether to deblur image 512 based on image 512 and optical-flow map 516.

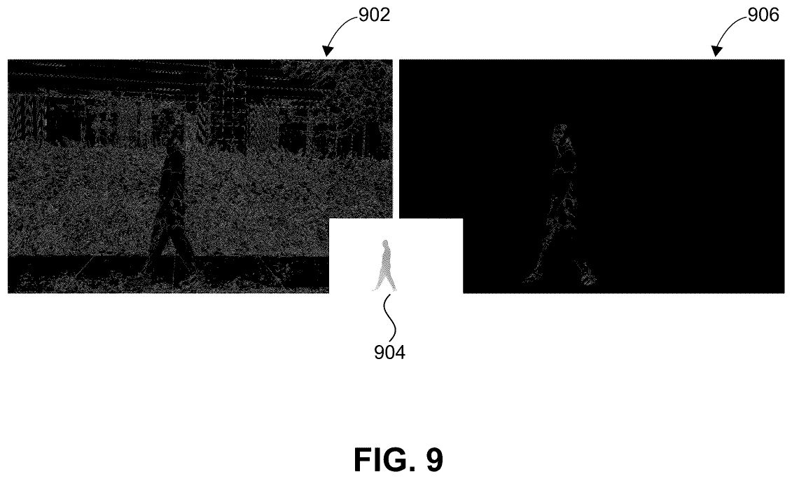

Edge detector 802 of blur detector 518 may detect edges of image 512 according to an edge-detection technique. For example, edge detector 802 may employ a filter, such as a high-pass image filter to determine edges of image 512. Edges 902 of FIG. 9 is an example of edges of an image. For example, edges 902 may represent edges of image 708 of FIG. 7.

Returning to FIG. 8, edge filter 804 of blur detector 518 may filter the edges identified by edge detector 802 based on optical-flow map 516. For example, edge filter 804 may identify edges that relate to moving subjects (e.g., based on optical-flow map 516). For instance, edge filter 804 may identify edges of image 512 that represent moving subjects. For example, edges 906 of FIG. 9 is an example of edges of edges 902 that represent a subject that is moving. Edge filter 804 may filter edges 902 based on optical flow map 904 to generate edges 906.

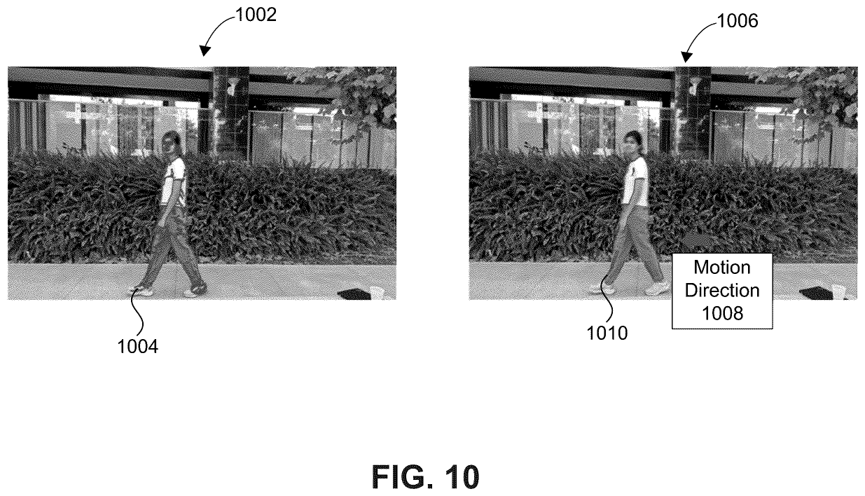

Returning to FIG. 8, edge selector 806 of blur detector 518 may select edges (of the edges identified by edge filter 804) that are perpendicular to a direction of motion of a moving subject. For example, edge selector 806 may identify (or obtain) a motion direction, which may generally represent a direction of motion of pixels a prior image (e.g., of images 508) and image 512 and/or between image 512 and a subsequent image (e.g., of images 508). The motion direction may be based on optical motion vectors. For example, edges 1004 of image 1002 of FIG. 10 may represent all edges of the moving subject. Edges 1010 of image 1006 of FIG. 10 may represent all of edges 1004 that are perpendicular to motion direction 1008. Edges 1010 may exhibit more blur than edges 1004 that are not perpendicular to motion direction 1008. Thus, edge selector 806 may identify the blurriest edges of image 512.

Returning to FIG. 8, edge-width determiner 808 may determine a width of edges selected by edge selector 806. For example, edge-width determiner 808 may determine a pixel width of the edges selected by edge selector 806.

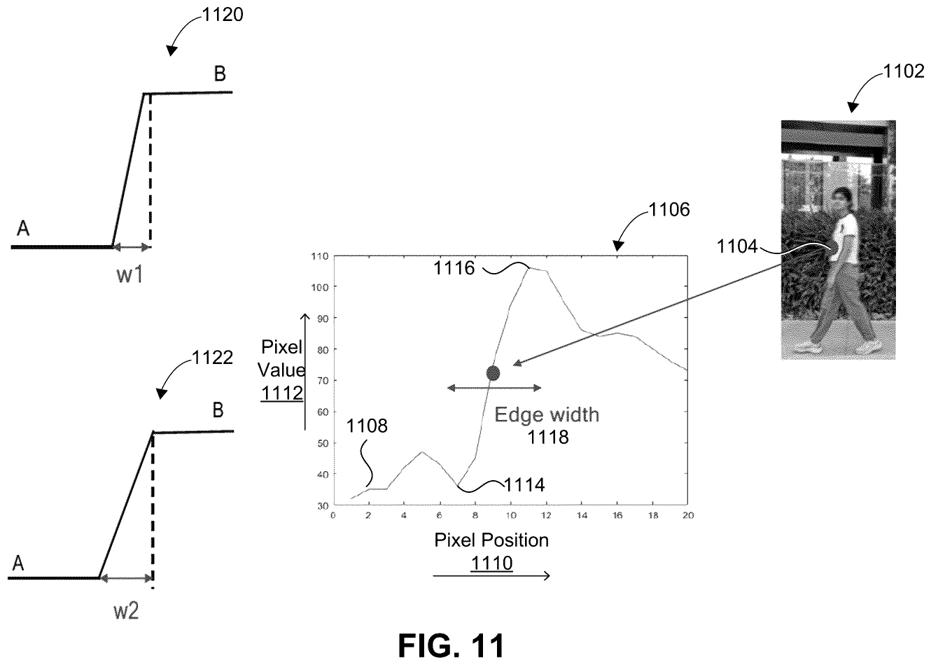

For example, graph 1106 of FIG. 11 illustrates pixel values 1108 of an edge 1104 of image 1102. An x axis of graph 1106 represents pixel position 1110. For example, based on the subject moving to the left, pixel position 1110 may represent pixel positions along a line parallel to the motion direction, for example, left to right in this example. A y axis of graph 1106 may represent pixel values (e.g., luma values) of the pixels at pixel positions 1110.

To the left of low pixel value 1114, pixel value 1108 may correspond to a background of image 1102. Based on this example, pixel values 1108 to the left of low pixel value 1114 may be relatively low based on image 1102 being dark to a left of the moving subject. To the right of high pixel value 1116, pixel values 1108 may correspond to the moving subject of image 1102. Based on this example, pixel values 1108 to the right of high pixel value 1116 may be relatively high based the moving subject being bright in image 1102.

In any case, the difference, in pixel value 1108, between low pixel value 1114 and high pixel value 1116 may indicate an edge (e.g., between the moving subject and the background). Edge width 1118 represents a width of the edge, in other words a number of pixels between pixels that represent the background and pixels that represent the moving subject. Pixel values 1108 between low pixel value 1114 and high pixel value 1116 may be based on both the moving subject and the background. For example, pixel values 1108 between low pixel value 1114 and high pixel value 1116 may be based on light reflected from the moving subject and from the background.

A narrow edge width, such as the example edge width w1 illustrated graph 1120, may appear as a sharp edge. A broad edge width, such as example edge width w2 illustrated graph 1122, may appear as a blurry edge.

An edge may have multiple widths. For example, edge 1104 may be several pixels long in a height dimension of image 1102. Widths may be determined for multiple points (in a direction perpendicular to the motion direction) along any given edge.

Returning to FIG. 8, edge-width determiner 808 may determine a pixel width of edges selected by edge selector 806. Blur determiner 810 may determine whether to deblur image 512 based on the pixel width of the selected edges. For example, blur determiner 810 may apply one or more thresholds to the pixel widths of the selected edges to determine whether to deblur image 512.

For example, if a point of an edge (e.g., any point of edge that is defined in a direction perpendicular to the motion direction) is five or fewer pixels wide, edge-width determiner 808 may determine that the point of the edge is sufficiently clear. Alternatively, if a point of an edge is six or more pixels wide, edge-width determiner 808 may determine that the point of the edge is blurry.

Further, edge-width determiner 808 may determine whether to deblur image 512 based on how many points of edges are blurry. For example, if more than a certain number of points of edges are blurry, edge-width determiner 808 may determine to deblur image 512. Alternatively, if fewer than the certain number of points of edges are blurry, edge-width determiner 808 may determine to not deblur image 512. As another example, edge-width determiner 808 may determine an average blurriness of each edge of the edges selected by edge selector 806 (e.g., by averaging widths of the edges). Edge-width determiner 808 may determine whether to deblur image 512 based on how many of the edges selected by edge selector 806 are blurry.

Blur removal can be a computationally heavy task. Blur removal can lead to detail loss if applied in portions of an image that are not blurry. Blur detector 518 can identify when it is practical to deblur an image. By limiting when system 500 deblurs images, system 500 is more computationally feasible because system 500 does not deblur sharp images. Additionally or alternatively, blur detector 518 can identify images in which the motion blur is beyond the scope of deblurrer 530.

FIG. 12 is a block diagram illustrating an example of deblurrer 530 of FIG. 5 to provide additional detail regarding operations of deblurrer 530, according to various aspects of the present disclosure. Blur detector 518 may include encoder neural networks and decoder neural networks arranged in a U-net architecture. In general, blur detector 518 may encode and decode image portion 528 based on optical-flow map 516 to generate image portion 532.

For example, deblurrer 530 may include a block 1202 at which optical-flow map 516 and image portion 528 may be encoded as features. Block 1202 may provide the features to block 1204. Block 1202 may also provide the features to block 1210 in a skip connection. Block 1204 may further encode the features provided by block 1202 and provide the further encoder features to block 1206. Block 1204 may also provide the features to block 1208 in a skip connection. Block 1206 may further encode the features provided by block 1204 and provide the encoded features to block 1208. At block 1208, the features provided by block 1204 (via the skip connection) may be combined (e.g., concatenated) with the features provided by block 1206. Block 1208 may decode the combined features and provide the result to block 1210. At block 1210, the features provided by block 1202 (via the skip connection) may be combined (e.g., concatenated) with the features provided by block 1208. Block 1210 may decode the combined features to generate image portion 532.

Deblurrer 530 may include any number of layers (e.g., blocks). In some cases, deblurrer 530 may additionally include pooling layers and combiners (not illustrated in FIG. 12). In some aspects, deblurrer 530 may be trained using images derived from video data (e.g., comprised of successive image frames). In some aspects, deblurrer 530 may be trained using images derived from video data with a high frame rate (such as 120 frames per second (fps), 240 fps, 360 fps, etc.). In some examples, deblurrer 530 may be trained a dataset including motion-blurred images and deblurred images. Optical-flow map 516 is included as a channel input because deblurrer 530 focuses on motion blurring and optical-flow map 516 indicates motion.

FIG. 13 is a block diagram illustrating an example of combiner 534 of FIG. 5 to provide additional detail regarding operations of combiner 534, according to various aspects of the present disclosure. In general, combiner 534 may combine pixels of image portion 532 with image 524 to generate image 536.

Deblur extractor 1302 of combiner 534 identify pixels of image portion 532 to add to image 524. For example, deblur extractor 1302 may identify pixels of image portion 532 that were deblurred by deblurrer 530. In many cases, the deblurred pixels represent edges of moving subjects. As such, deblur extractor 1302 may identify pixels based on optical-flow map 516 (which is indicative of moving subjects).

Image blender 1304 of combiner 534 may combine pixels of image portion 532 with image 524. For example, image blender 1304 may add pixels of image portion 532 (e.g., as identified by deblur extractor 1302) to pixels of image 524. For instance, image blender 1304 may replace pixels of image 524 that correspond to pixels of image portion 532 (e.g., as identified by deblur extractor 1302) with pixels of image portion 532.

In some aspects, image blender 1304 may blend pixels of image portion 532 with pixels of image 524. For example, pixels at edges of the identified pixels of image portion 532 may be blended (e.g., via alpha blending) with corresponding pixels of image 524.

Deblurred image portions might adversely affect non blur regions of images. Thus, deblur extractor 1302 may identify the regions of image portion 532 that were deblurred and ignore the rest. Since image portion 532 has a different noise profile that image 524, image blending may be applied to reduce border artifacts. By ignoring non-blur regions of the image (e.g., of image 524), adverse effects of a blur removal may be decreased. Narrowing the scope of deblurring allows system 500 to provide a cropped image (e.g., image portion 532) to deblurrer 530 which significantly improves network speed and memory requirements.

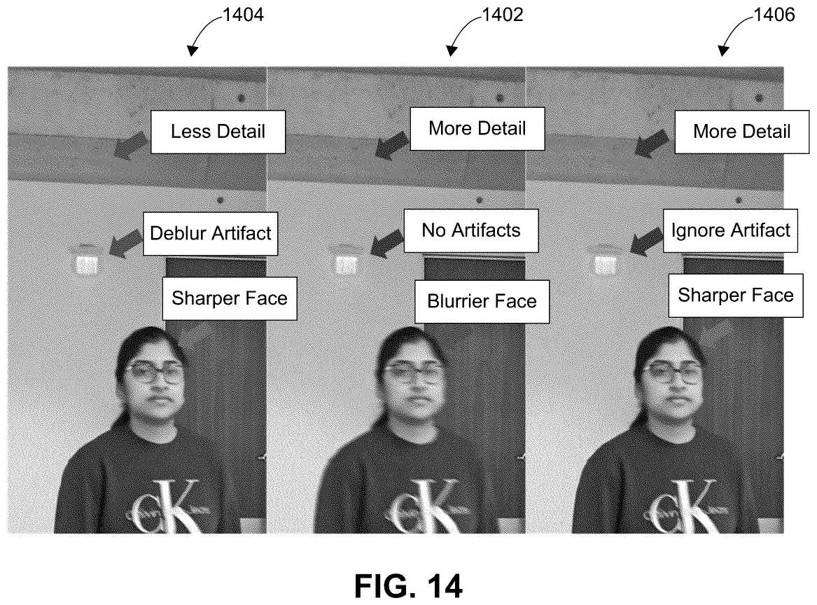

FIG. 14 includes three example images to illustrate performance of system 500 of FIG. 5, according to various aspects of the present disclosure. For example, FIG. 14 includes image 1402, which may be an example of a captured image (e.g., one of images 504, for example, image 512). Image 1402 includes clear pixels in the background and blurry pixels representing the face of the subject, for example, based on the subject having moved while image 1402 was captured.

FIG. 14 includes image 1404 which may be an example of an image 1402 if all of image 1402 were deblurred. Debluring image 1402 to generate image 1404 may result in clearer pixels representing the face of the subject. However deblurring the background of image 1402 to generate image 1404 may result in less detail in the background of image 1404 and/or in the introduction of artifacts in the background of image 1404.

FIG. 14 includes image 1406 which may be an example of image 1402 if image 1402 were deblurred by system 500, according to various aspects of the present disclosure. In deblurring image 1402, system 500 may deblur pixels representing the face of the subject (e.g., based on cropper 526 identifying the blurry portion of image 1402). Thus, pixels of image 1406 representing the face of the subject may be clearer than the corresponding pixels of image 1402. Yet, because system 500 may not deblur the background, image 1406 may retain the details of image 1402 in the background. Further, because system 500 may not deblur the background, system 500 may not add artifacts in the background of image 1406.

FIG. 15 is a block diagram illustrating an example of image evaluator 538 of FIG. 5 to provide additional detail regarding operations of image evaluator 538, according to various aspects of the present disclosure. In general, image evaluator 538 may compare image 536 with image 524 according to a number of factors and determine which of image 536 or image 524 is better according to the number of factors.

For example, signal-to-noise ratio (SNR) determiner 1502 may determine an SNR (e.g., a peak SNR (PSNR)) of image 536. Likewise, SNR determiner 1508 may determine an SNR of image 524. Evaluator 1514 may use the determined SNRs as a factor in determining which of image 524 or image 536 is better. For example, a stronger SNR may weigh in favor of being the better image.

Facial-landmark detector 1504 may detect and/or identify facial landmarks in image 536 and facial-landmark detector 1510 may detect and/or identify facial landmarks in image 524. Facial-landmark detector 1504 and/or facial-landmark detector 1510 may be, or may include, one or more machine-learning models trained to detect and/or identify facial landmarks (e.g., eyes, noses, and/or mouths). Evaluator 1514 may evaluate a performance of facial-landmark detector 1504 on image 536 against a performance of facial-landmark detector 1510 on image 524. For example, evaluator 1514 may compare how well facial-landmark detector 1504 is able to detect facial landmarks in image 536 with how well facial-landmark detector 1510 is able to detect facial landmarks in image 524. Evaluator 1514 may use the comparison between the performance of facial-landmark detector 1504 and facial-landmark detector 1510 as a factor in determining which of image 524 or image 536 is better. For example, more accurately-identified facial landmarks may weigh in favor of being the better image.

Human recognizer 1506 may detect humans in image 536 and human recognizer 1512 may detect humans in image 524. Human recognizer 1506 and human recognizer 1512 may be, or may include, one or more machine-learning models trained to detect humans based on images. Evaluator 1514 may evaluate a performance of human recognizer 1506 on image 536 against a performance of human recognizer 1512 on image 524. For example, evaluator 1514 may compare how well human recognizer 1506 is able to detect humans in image 536 with how well human recognizer 1512 is able to detect humans in image 524. Evaluator 1514 may use the comparison between the performance of human recognizer 1506 and human recognizer 1512 as a factor in determining which of image 524 or image 536 is better. For example, more accurately-identified humans may weigh in favor of being the better image.

Image evaluator 538 is illustrated as including SNR determiner 1502 and SNR determiner 1508 for descriptive purposes. In some aspects, image evaluator 538 may include a single SNR determiner that may determine an SNR of image 536 and an SNR of image 524. Similarly, in some aspects, image evaluator 538 may include a single facial-landmark detector that may detect facial landmarks in image 536 and in image 524. Further, in some aspects, image evaluator 538 may include a single human recognizer that may detect humans in image 536 and in image 524.

In some aspects, image evaluator 538 may not include all of SNR determiner 1502, facial-landmark detector 1504, human recognizer 1506, SNR determiner 1508, facial-landmark detector 1510, and human recognizer 1512. As such, image evaluator 538 may not use all of SNR, an ability to detect facial landmarks, and an ability to detect humans as factors when comparing image 536 and image 524. Additionally or alternatively, image evaluator 538 may use other factors when comparing image 536 and image 524.

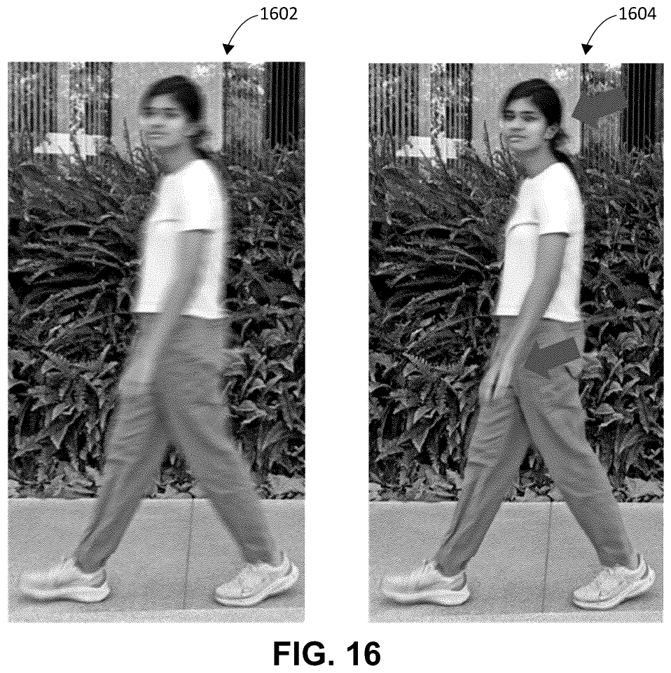

FIG. 16 includes two example images to illustrate a case in which an original image (e.g., image 524) may be better than an image including a deblurred portion (e.g., image 536). For example, image 1602 of FIG. 16 is an example of an original image (e.g., image 524) and image 1604 is an example of an image including a deblurred portion. Image 1604 includes artifacts (e.g., at a hand of the subject). Thus, image 1602 may be better than image 1604. Image evaluator 538 may determine that image 1602 is better than image 1604 based on one or more factors (e.g., human detection and/or facial landmark detection).

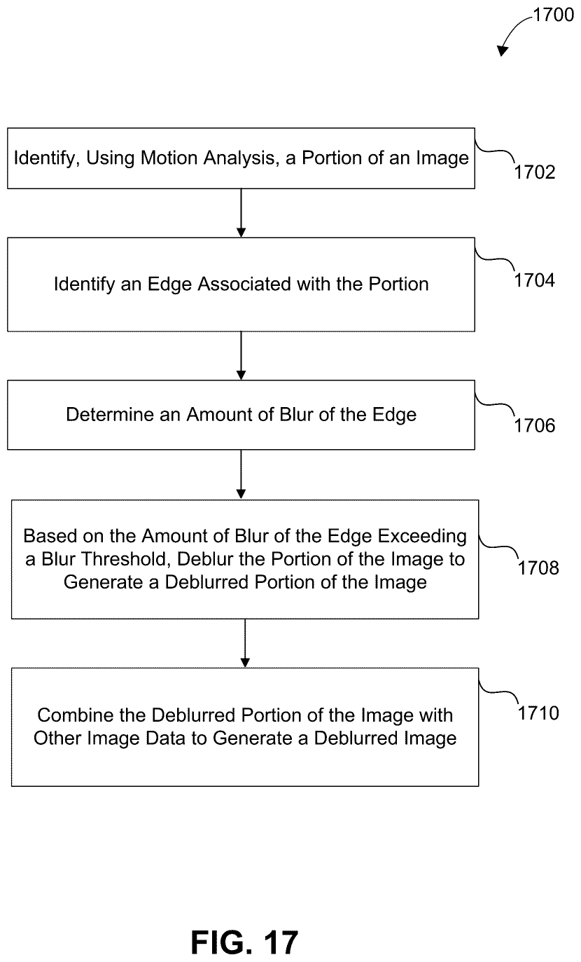

FIG. 17 is a flow diagram illustrating a process 1700 for deblurring images, in accordance with aspects of the present disclosure. One or more operations of process 1700 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 1700. The one or more operations of process 1700 may be implemented as software components that are executed and run on one or more processors.

At block 1702, a computing device (or one or more components thereof) may identify, using motion analysis, a portion of an image. For example, optical flow determiner 514 of FIG. 5 may generate optical-flow map 516 of FIG. 5, for example, as described with regard to FIG. 6A, FIG. 6B, and FIG. 6C. Further, cropper 526 of FIG. 5 may identify image portion 528 of FIG. 5 of image 524 of FIG. 5, for example, as described with regard to FIG. 7.

At block 1704, the computing device (or one or more components thereof) may identify an edge associated with the portion. For example, edge detector 802 of FIG. 8 of blur detector 518 of FIG. 5 and FIG. 8 may determine an edge of image 512 of FIG. 5 based on optical-flow map 516, for example, as described with regard to FIG. 9 and FIG. 10.

In some aspects, the edge may be associated with an object depicted in the image and the portion of the image includes the object. For example, the edge determined by blur detector 518 may relate to an object in image 512.

In some aspects, to identify the edge associated with the portion, the computing device (or one or more components thereof) may identify a moving object based on a motion analysis of multiple images including the image and identify edges of the moving object using an edge-detection technique. For example, optical flow determiner 514 may determine optical-flow map 516 based on images 508, for example as described with regard to FIG. 6A, FIG. 6B, and FIG. 6C. Further edge detector 802 of FIG. 8 of blur detector 518 of FIG. 5 and FIG. 8 may determine an edge of image 512 of FIG. 5 based on optical-flow map 516, for example, as described with regard to FIG. 9 and FIG. 10.

In some aspects, to identify the edge associated with the portion, the computing device (or one or more components thereof) may identify a motion direction associated with the moving object based on a motion analysis of multiple images including the image and identify the edge based on an angle between the edge and the motion direction. For example, edge filter 804 of FIG. 8 of blur detector 518 of FIG. 5 and FIG. 8 may determine a motion direction 1008 of FIG. 10 associated with a moving object, for example, as determined by optical flow determiner 514 of FIG. 5. Further, edge filter 804 may determine edges 1010 of FIG. 10 based on an angle between edges 1010 and motion direction 1008. For example, edge filter 804 may determine edges 1010 based on edges 1010 being perpendicular or substantially perpendicular to motion direction 1008, for instance based on an angle between 75 and 105 degrees between edges 1010 and motion direction 1008.

At block 1706, the computing device (or one or more components thereof) may determine an amount of blur of the edge. For example, blur detector 518 of FIG. 5 may determine an amount of blur of the edge, for example, as described with regard to FIG. 8, FIG. 9, FIG. 10, and FIG. 11.

In some aspects, the amount of blur of the edge may be based on a number of pixels that are based on light reflected from a moving object and light reflected from a background behind the moving object. For example, edge-width determiner 808 of FIG. 8 may determine a number of pixels that represent a foreground object and a background. For example, edge-width determiner 808 may determine edge width 1118 of FIG. 11 based on edge width 1118 between low pixel value 1114 and high pixel value 1116.

In some aspects, the amount of blur of the edge is based on a transition width. For example, edge-width determiner 808 of FIG. 8 may determine edge width 1118 of FIG. 11 based on edge width 1118 between low pixel value 1114 and high pixel value 1116.

At block 1708, the computing device (or one or more components thereof) may based on the amount of blur of the edge exceeding a blur threshold, deblur the portion of the image to generate a deblurred portion of the image. For example, based on determination 520 of FIG. 5, deblurrer 530 of FIG. 5 may deblur image portion 528 to generate image portion 532 of FIG. 5.

In some aspects, to deblur the portion of the image, the at least one processor is configured to process the portion of the image using a machine-learning model that is trained to deblur images. For example, deblurrer 530 of FIG. 5 may deblur image portion 528.

At block 1710, the computing device (or one or more components thereof) may combine the deblurred portion of the image with other image data to generate a deblurred image. For example, combiner 534 of FIG. 5 may combine image portion 532 with image 524 to generate image 536.

In some aspects, the other image data may be, or may include, image data from the image. For example, image portion 528 may be cropped from image 524 and image portion 532 may be combined with portions of image 524.

In some aspects, the image may be, or may include, a first image and the other image data may be, or may include, image data from a second image. For example, image portion 528 may be cropped from one of images 504 and image portion 532 may be combine with portions of another one of images 504.

In some aspects, to combine the deblurred portion of the image with the other image data, the at least one processor is configured to blend pixels of edges of the deblurred portion of the image with corresponding pixels of the other image data. For example, combiner 534 of FIG. 5 may blend pixels at an edge of image portion 532 with corresponding pixels of image 524.

In some aspects, the computing device (or one or more components thereof) may compare deblurred image with the image to determine a final image; and at least one of: store the final image; display the final image; process the final image; or transmit the final image. For example, image evaluator 538 of FIG. 5 may compare image 536 of FIG. 5 with image 524 of FIG. 5. Image evaluator 538 may determine the better of image 536 and image 524 and output image 540 as the better of image 536 and image 524. System 500 may store image 540, display image 540, process image 540, and/or transmit image 540.

In some aspects, the final image is determined based on at least one of: a comparison of signal-to-noise ratios of the image and the deblurred image; a comparison of facial landmarks in the image and the deblurred image; or a comparison of human recognizability in the image and the deblurred image. For example, image evaluator 538 may compare image 536 with image 524 based on a comparison of signal-to-noise ratios of image 536 and image 524, a comparison of facial landmarks in image 536 and image 524, and/or a comparison of human recognizability in image 536 and image 524.

In some examples, as noted previously, the methods described herein (e.g., process 1700 of FIG. 17, and/or other methods described herein) can be performed, in whole or in part, by a computing device or apparatus. In one example, one or more of the methods can be performed by system 500 of FIG. 5, or by another system or device. In another example, one or more of the methods (e.g., process 1700 of FIG. 17, and/or other methods described herein) can be performed, in whole or in part, by the computing-device architecture 2000 shown in FIG. 20. For instance, a computing device with the computing-device architecture 2000 shown in FIG. 20 can include, or be included in, the components of the system 500 and can implement the operations of process 1700, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 1700, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1700, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

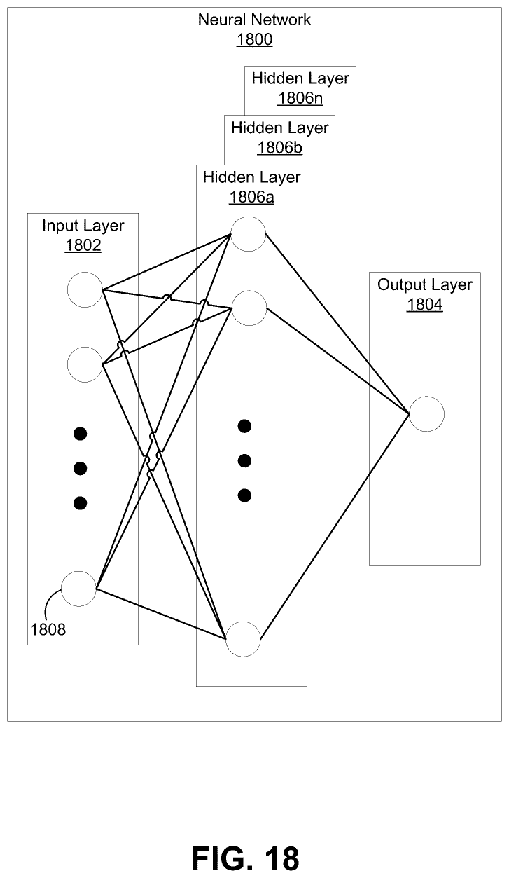

FIG. 18 is an illustrative example of a neural network 1800 (e.g., a deep-learning neural network) that can be used to implement machine-learning based feature segmentation, implicit-neural-representation generation, rendering, classification, object detection, image recognition (e.g., face recognition, object recognition, scene recognition, etc.), feature extraction, authentication, gaze detection, gaze prediction, and/or automation. For example, neural network 1800 may be an example of, or can implement, sharpness detector 510 of FIG. 5, optical flow determiner 514 of FIG. 5, deblurrer 530 of FIG. 5 and FIG. 12, block 1202 of FIG. 12, block 1204 of FIG. 12, block 1206 of FIG. 12, block 1208 of FIG. 12, block 1210 of FIG. 12, facial-landmark detector 1504 of FIG. 15, human recognizer 1506 of FIG. 15, facial-landmark detector 1510 of FIG. 15, and/or human recognizer 1512 of FIG. 15.

An input layer 1802 includes input data. In one illustrative example, input layer 1802 can include data representing images 508 of FIG. 5, image 512 of FIG. 5, optical-flow map 516 of FIG. 5 and FIG. 12, image portion 528 of FIG. 5 and FIG. 12, image 524 of FIG. 5, FIG. 15, and/or image 536 of FIG. 15. Neural network 1800 includes multiple hidden layers hidden layers 1806a, 1806b, through 1806n. The hidden layers 1806a, 1806b, through hidden layer 1806n include “n” number of hidden layers, where “n” is an integer greater than or equal to one. The number of hidden layers can be made to include as many layers as needed for the given application. Neural network 1800 further includes an output layer 1804 that provides an output resulting from the processing performed by the hidden layers 1806a, 1806b, through 1806n. In one illustrative example, output layer 1804 can provide image 512 of FIG. 5, optical-flow map 516 of FIG. 5, image portion 532 of FIG. 5 and FIG. 12, and/or outputs of facial-landmark detector 1504 of FIG. 15, human recognizer 1506 of FIG. 15, facial-landmark detector 1510 of FIG. 15, and/or human recognizer 1512 of FIG. 15.

Neural network 1800 may be, or may include, a multi-layer neural network of interconnected nodes. Each node can represent a piece of information. Information associated with the nodes is shared among the different layers and each layer retains information as information is processed. In some cases, neural network 1800 can include a feed-forward network, in which case there are no feedback connections where outputs of the network are fed back into itself. In some cases, neural network 1800 can include a recurrent neural network, which can have loops that allow information to be carried across nodes while reading in input.

Information can be exchanged between nodes through node-to-node interconnections between the various layers. Nodes of input layer 1802 can activate a set of nodes in the first hidden layer 1806a. For example, as shown, each of the input nodes of input layer 1802 is connected to each of the nodes of the first hidden layer 1806a. The nodes of first hidden layer 1806a can transform the information of each input node by applying activation functions to the input node information. The information derived from the transformation can then be passed to and can activate the nodes of the next hidden layer 1806b, which can perform their own designated functions. Example functions include convolutional, up-sampling, data transformation, and/or any other suitable functions. The output of the hidden layer 1806b can then activate nodes of the next hidden layer, and so on. The output of the last hidden layer 1806n can activate one or more nodes of the output layer 1804, at which an output is provided. In some cases, while nodes (e.g., node 1808) in neural network 1800 are shown as having multiple output lines, a node has a single output and all lines shown as being output from a node represent the same output value.

In some cases, each node or interconnection between nodes can have a weight that is a set of parameters derived from the training of neural network 1800. Once neural network 1800 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 1800 to be adaptive to inputs and able to learn as more and more data is processed.

Neural network 1800 may be pre-trained to process the features from the data in the input layer 1802 using the different hidden layers 1806a, 1806b, through 1806n in order to provide the output through the output layer 1804. In an example in which neural network 1800 is used to identify features in images, neural network 1800 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 1800 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until neural network 1800 is trained well enough so that the weights of the layers are accurately tuned.

For the example of identifying objects in images, the forward pass can include passing a training image through neural network 1800. The weights are initially randomized before neural network 1800 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 1800, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 1800 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as Eₜₒₜₐₗ=Σ½(target−output)². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 1800 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ−ηdW/dL, where w denotes a weight, wᵢ denotes the initial weight, and η denotes a learning rate. The learning rate can be set to any suitable value, with a high learning rate including larger weight updates and a lower value indicating smaller weight updates.

Neural network 1800 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 1800 can include any other deep network other than a CNN, such as an autoencoder, a deep belief nets (DBNs), a Recurrent Neural Networks (RNNs), among others.

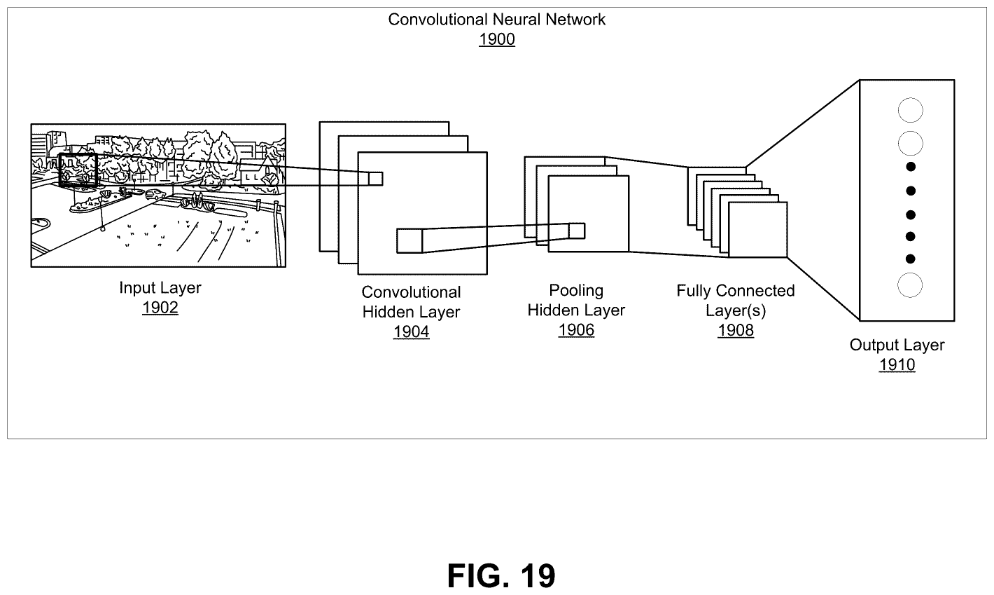

FIG. 19 is an illustrative example of a convolutional neural network (CNN) 1900. The input layer 1902 of the CNN 1900 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1904, an optional non-linear activation layer, a pooling hidden layer 1906, and fully connected layer 1908 (which fully connected layer 1908 can be hidden) to get an output at the output layer 1910. While only one of each hidden layer is shown in FIG. 19, one of ordinary skill will appreciate that multiple convolutional hidden layers, non-linear layers, pooling hidden layers, and/or fully connected layers can be included in the CNN 1900. As previously described, the output can indicate a single class of an object or can include a probability of classes that best describe the object in the image.

The first layer of the CNN 1900 can be the convolutional hidden layer 1904. The convolutional hidden layer 1904 can analyze image data of the input layer 1902. Each node of the convolutional hidden layer 1904 is connected to a region of nodes (pixels) of the input image called a receptive field. The convolutional hidden layer 1904 can be considered as one or more filters (each filter corresponding to a different activation or feature map), with each convolutional iteration of a filter being a node or neuron of the convolutional hidden layer 1904. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1904. Each connection between a node and a receptive field for that node learns a weight and, in some cases, an overall bias such that each node learns to analyze its particular local receptive field in the input image. Each node of the convolutional hidden layer 1904 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 1904 is due to each node of the convolutional layer being applied to its corresponding receptive field. For example, a filter of the convolutional hidden layer 1904 can begin in the top-left corner of the input image array and can convolve around the input image. As noted above, each convolutional iteration of the filter can be considered a node or neuron of the convolutional hidden layer 1904. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1904. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1904.

The mapping from the input layer to the convolutional hidden layer 1904 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1904 can include several activation maps in order to identify multiple features in an image. The example shown in FIG. 19 includes three activation maps. Using three activation maps, the convolutional hidden layer 1904 can detect three different kinds of features, with each feature being detectable across the entire image.

In some examples, a non-linear hidden layer can be applied after the convolutional hidden layer 1904. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 1900 without affecting the receptive fields of the convolutional hidden layer 1904.

The pooling hidden layer 1906 can be applied after the convolutional hidden layer 1904 (and after the non-linear hidden layer when used). The pooling hidden layer 1906 is used to simplify the information in the output from the convolutional hidden layer 1904. For example, the pooling hidden layer 1906 can take each activation map output from the convolutional hidden layer 1904 and generates a condensed activation map (or feature map) using a pooling function. Max-pooling is one example of a function performed by a pooling hidden layer. Other forms of pooling functions be used by the pooling hidden layer 1906, such as average pooling, L2-norm pooling, or other suitable pooling functions. A pooling function (e.g., a max-pooling filter, an L2-norm filter, or other suitable pooling filter) is applied to each activation map included in the convolutional hidden layer 1904. In the example shown in FIG. 19, three pooling filters are used for the three activation maps in the convolutional hidden layer 1904.

In some examples, max-pooling can be used by applying a max-pooling filter (e.g., having a size of 2×2) with a stride (e.g., equal to a dimension of the filter, such as a stride of 2) to an activation map output from the convolutional hidden layer 1904. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1904 having a dimension of 24×24 nodes, the output from the pooling hidden layer 1906 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1900.

The final layer of connections in the network is a fully-connected layer that connects every node from the pooling hidden layer 1906 to every one of the output nodes in the output layer 1910. Using the example above, the input layer includes 28×28 nodes encoding the pixel intensities of the input image, the convolutional hidden layer 1904 includes 3×24×24 hidden feature nodes based on application of a 5×5 local receptive field (for the filters) to three activation maps, and the pooling hidden layer 1906 includes a layer of 3×12×12 hidden feature nodes based on application of max-pooling filter to 2×2 regions across each of the three feature maps. Extending this example, the output layer 1910 can include ten output nodes. In such an example, every node of the 3×12×12 pooling hidden layer 1906 is connected to every node of the output layer 1910.

The fully connected layer 1908 can obtain the output of the previous pooling hidden layer 1906 (which should represent the activation maps of high-level features) and determines the features that most correlate to a particular class. For example, the fully connected layer 1908 can determine the high-level features that most strongly correlate to a particular class and can include weights (nodes) for the high-level features. A product can be computed between the weights of the fully connected layer 1908 and the pooling hidden layer 1906 to obtain probabilities for the different classes. For example, if the CNN 1900 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1910 can include an M-dimensional vector (in the prior example, M=10). M indicates the number of classes that the CNN 1900 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 20 illustrates an example computing-device architecture 2000 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 2000 may include, implement, or be included in any or all of system 500 of FIG. 5. Additionally or alternatively, computing-device architecture 2000 may be configured to perform process 1700, and/or other process described herein.

The components of computing-device architecture 2000 are shown in electrical communication with each other using connection 2012, such as a bus. The example computing-device architecture 2000 includes a processing unit (CPU or processor) 2002 and computing device connection 2012 that couples various computing device components including computing device memory 2010, such as read only memory (ROM) 2008 and random-access memory (RAM) 2006, to processor 2002.

Computing-device architecture 2000 can include a cache of high-speed memory connected directly with, in close proximity to, or integrated as part of processor 2002. Computing-device architecture 2000 can copy data from memory 2010 and/or the storage device 2014 to cache 2004 for quick access by processor 2002. In this way, the cache can provide a performance boost that avoids processor 2002 delays while waiting for data. These and other modules can control or be configured to control processor 2002 to perform various actions. Other computing device memory 2010 may be available for use as well. Memory 2010 can include multiple different types of memory with different performance characteristics. Processor 2002 can include any general-purpose processor and a hardware or software service, such as service 1 2016, service 2 2018, and service 3 2020 stored in storage device 2014, configured to control processor 2002 as well as a special-purpose processor where software instructions are incorporated into the processor design. Processor 2002 may be a self-contained system, containing multiple cores or processors, a bus, memory controller, cache, etc. A multi-core processor may be symmetric or asymmetric.

To enable user interaction with the computing-device architecture 2000, input device 2022 can represent any number of input mechanisms, such as a microphone for speech, a touch-sensitive screen for gesture or graphical input, keyboard, mouse, motion input, speech and so forth. Output device 2024 can also be one or more of a number of output mechanisms known to those of skill in the art, such as a display, projector, television, speaker device, etc. In some instances, multimodal computing devices can enable a user to provide multiple types of input to communicate with computing-device architecture 2000. Communication interface 2026 can generally govern and manage the user input and computing device output. There is no restriction on operating on any particular hardware arrangement and therefore the basic features here may easily be substituted for improved hardware or firmware arrangements as they are developed.

Storage device 2014 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 2006, read only memory (ROM) 2008, and hybrids thereof. Storage device 2014 can include services 2016, 2018, and 2020 for controlling processor 2002. Other hardware or software modules are contemplated. Storage device 2014 can be connected to the computing device connection 2012. In one aspect, a hardware module that performs a particular function can include the software component stored in a computer-readable medium in connection with the necessary hardware components, such as processor 2002, connection 2012, output device 2024, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per sc.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, (e.g., a combination of a DSP and a microprocessor, a plurality of microprocessors, one or more microprocessors in conjunction with a DSP core, or any other such configuration). Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for deblurring images, the apparatus comprising: at least one memory; and at least one processor coupled to the at least one memory and configured to: identify, using motion analysis, a portion of an image; identify an edge associated with the portion; determine an amount of blur of the edge; based on the amount of blur of the edge exceeding a blur threshold, deblur the portion of the image to generate a deblurred portion of the image; and combine the deblurred portion of the image with other image data to generate a deblurred image.

Aspect 2. The apparatus of aspect 1, wherein the edge is associated with an object depicted in the image and wherein the portion of the image includes the object.

Aspect 3. The apparatus of any one of aspects 1 or 2, wherein, to identify the edge associated with the portion, the at least one processor is configured to: identify a moving object based on a motion analysis of multiple images including the image; and identify edges of the moving object using an edge-detection technique.

Aspect 4. The apparatus of aspect 3, wherein, to identify the edge associated with the portion, the at least one processor is configured to: identify a motion direction associated with the moving object based on a motion analysis of multiple images including the image; and identify the edge based on an angle between the edge and the motion direction.

Aspect 5. The apparatus of any one of aspects 1 to 4, wherein the amount of blur of the edge is based on a number of pixels that are based on light reflected from a moving object and light reflected from a background behind the moving object.

Aspect 6. The apparatus of any one of aspects 1 to 5, wherein the amount of blur of the edge is based on a transition width.

Aspect 7. The apparatus of any one of aspects 1 to 6, wherein, to deblur the portion of the image, the at least one processor is configured to process the portion of the image using a machine-learning model that is trained to deblur images.

Aspect 8. The apparatus of any one of aspects 1 to 7, wherein, to combine the deblurred portion of the image with the other image data, the at least one processor is configured to blend pixels of edges of the deblurred portion of the image with corresponding pixels of the other image data.

Aspect 9. The apparatus of any one of aspects 1 to 8, wherein the at least one processor is configured to: compare deblurred image with the image to determine a final image; and at least one of: store the final image; display the final image; process the final image; or transmit the final image.

Aspect 10. The apparatus of aspect 9, wherein the final image is determined based on at least one of: a comparison of signal-to-noise ratios of the image and the deblurred image; a comparison of facial landmarks in the image and the deblurred image; or a comparison of human recognizability in the image and the deblurred image.

Aspect 11. The apparatus of any one of aspects 1 to 10, wherein the other image data comprises image data from the image.

Aspect 12. The apparatus of any one of aspects 1 to 11, wherein the image comprises a first image and wherein the other image data comprises image data from a second image.

Aspect 13. A method for deblurring images, the method comprising: identifying, using motion analysis, a portion of an image; identifying an edge associated with the portion; determining an amount of blur of the edge; based on the amount of blur of the edge exceeding a blur threshold, deblurring the portion of the image to generate a deblurred portion of the image; and combining the deblurred portion of the image with other image data to generate a deblurred image.

Aspect 14. The method of aspect 13, wherein the edge is associated with an object depicted in the image and wherein the portion of the image includes the object.

Aspect 15. The method of any one of aspects 13 or 14, wherein identifying the edge associated with the portion comprises: identifying a moving object based on a motion analysis of multiple images including the image; and identifying edges of the moving object using an edge-detection technique.

Aspect 16. The method of aspect 15, wherein identifying the edge associated with the portion further comprises: identifying a motion direction associated with the moving object based on a motion analysis of multiple images including the image; and identifying the edge based on an angle between the edge and the motion direction.

Aspect 17. The method of any one of aspects 13 to 16, wherein the amount of blur of the edge is based on a number of pixels that are based on light reflected from a moving object and light reflected from a background behind the moving object.

Aspect 18. The method of any one of aspects 13 to 17, wherein the amount of blur of the edge is based on a transition width.

Aspect 19. The method of any one of aspects 13 to 18, wherein deblurring the portion of the image comprises processing the portion of the image using a machine-learning model that is trained to deblur images.

Aspect 20. The method of any one of aspects 13 to 19, wherein combining the deblurred portion of the image with the other image data comprises blending pixels of edges of the deblurred portion of the image with corresponding pixels of the other image data.

Aspect 21. The method of any one of aspects 13 to 20, further comprising: comparing deblurred image with the image to determine a final image; and at least one of: storing the final image; displaying the final image; processing the final image; or transmitting the final image.

Aspect 22. The method of aspect 21, wherein the final image is determined based on at least one of: a comparison of signal-to-noise ratios of the image and the deblurred image; a comparison of facial landmarks in the image and the deblurred image; or a comparison of human recognizability in the image and the deblurred image.

Aspect 23. The method of any one of aspects 13 to 22, wherein the other image data comprises image data from the image.

Aspect 24. The method of any one of aspects 13 to 23, wherein the image comprises a first image and wherein the other image data comprises image data from a second image.

Aspect 25. A non-transitory computer-readable storage medium having stored thereon instructions that, when executed by at least one processor, cause the at least one processor to perform operations according to any of aspects 13 to 24.

Aspect 26. An apparatus for providing virtual content for display, the apparatus comprising one or more means for perform operations according to any of aspects 13 to 24.

What is claimed is:

1. An apparatus for deblurring images, the apparatus comprising:
at least one memory; and
at least one processor coupled to the at least one memory and configured to:
identify, using motion analysis, a portion of an image;
identify an edge associated with the portion;
determine an amount of blur of the edge;
based on the amount of blur of the edge exceeding a blur threshold, deblur the portion of the image to generate a deblurred portion of the image; and
combine the deblurred portion of the image with other image data to generate a deblurred image.

2. The apparatus of claim 1, wherein the edge is associated with an object depicted in the image and wherein the portion of the image includes the object.

3. The apparatus of claim 1, wherein, to identify the edge associated with the portion, the at least one processor is configured to:
identify a moving object based on a motion analysis of multiple images including the image; and
identify edges of the moving object using an edge-detection technique.

4. The apparatus of claim 3, wherein, to identify the edge associated with the portion, the at least one processor is configured to:
identify a motion direction associated with the moving object based on a motion analysis of multiple images including the image; and
identify the edge based on an angle between the edge and the motion direction.

5. The apparatus of claim 1, wherein the amount of blur of the edge is based on a number of pixels that are based on light reflected from a moving object and light reflected from a background behind the moving object.

6. The apparatus of claim 1, wherein the amount of blur of the edge is based on a transition width.

7. The apparatus of claim 1, wherein, to deblur the portion of the image, the at least one processor is configured to process the portion of the image using a machine-learning model that is trained to deblur images.

8. The apparatus of claim 1, wherein, to combine the deblurred portion of the image with the other image data, the at least one processor is configured to blend pixels of edges of the deblurred portion of the image with corresponding pixels of the other image data.

9. The apparatus of claim 1, wherein the at least one processor is configured to:
compare deblurred image with the image to determine a final image; and at least one of:
store the final image;
display the final image;
process the final image; or
transmit the final image.

10. The apparatus of claim 9, wherein the final image is determined based on at least one of:
a comparison of signal-to-noise ratios of the image and the deblurred image;
a comparison of facial landmarks in the image and the deblurred image; or
a comparison of human recognizability in the image and the deblurred image.

11. The apparatus of claim 1, wherein the other image data comprises image data from the image.

12. The apparatus of claim 1, wherein the image comprises a first image and wherein the other image data comprises image data from a second image.

13. A method for deblurring images, the method comprising:
identifying, using motion analysis, a portion of an image;
identifying an edge associated with the portion;
determining an amount of blur of the edge;
based on the amount of blur of the edge exceeding a blur threshold, deblurring the portion of the image to generate a deblurred portion of the image; and
combining the deblurred portion of the image with other image data to generate a deblurred image.

14. The method of claim 13, wherein the edge is associated with an object depicted in the image and wherein the portion of the image includes the object.

15. The method of claim 13, wherein identifying the edge associated with the portion comprises:
identifying a moving object based on a motion analysis of multiple images including the image; and
identifying edges of the moving object using an edge-detection technique.

16. The method of claim 15, wherein identifying the edge associated with the portion further comprises:
identifying a motion direction associated with the moving object based on a motion analysis of multiple images including the image; and
identifying the edge based on an angle between the edge and the motion direction.

17. The method of claim 13, wherein the amount of blur of the edge is based on a number of pixels that are based on light reflected from a moving object and light reflected from a background behind the moving object.

18. The method of claim 13, wherein the amount of blur of the edge is based on a transition width.

19. The method of claim 13, wherein deblurring the portion of the image comprises processing the portion of the image using a machine-learning model that is trained to deblur images.

20. The method of claim 13, wherein combining the deblurred portion of the image with the other image data comprises blending pixels of edges of the deblurred portion of the image with corresponding pixels of the other image data.
